(19) United States
(12) Patent Application Publication
(10) Pub. No.: US 2026/0175574 A1
(43) Pub. Date: Jun. 25, 2026

(54) LIQUID DISCHARGING HEAD

(71) Applicant: SEIKO EPSON CORPORATION, Tokyo (JP)

(72) Inventors: Takeru HATO, MATSUMOTO-SHI (JP); Harunobu KOIKE, MATSUMOTO-SHI (JP); Motoki TAKABE, SHIOJIRI-SHI (JP)

(21) Appl. No.: 19/426,253

(22) Filed: Dec. 19, 2025

(30) Foreign Application Priority Data
Dec. 24, 2024 (JP) 2024-227153

(51) Int. Cl. B41J 2/14

(52) U.S. Cl. CPC B41J 2/14233; B41J 2002/14241; B41J 2202/11

(57) ABSTRACT

A liquid discharging head includes a pressure chamber substrate that has a pressure chamber space partitioned by side walls, a vibration plate, a piezoelectric element that is formed on the vibration plate, and a protective film that is provided on the piezoelectric element. A protruding portion is formed toward an inside of the pressure chamber space is provided with respect to a surface of the side wall as a reference at a coupling section where at least one of the side walls present in a first direction which is a longitudinal direction of the pressure chamber space is in contact with the vibration plate, and when the pressure chamber is viewed in plan view, the protective film is provided from and outside to the inside of the pressure chamber up to a position that covers at least the protruding portion.

The present application is based on, and claims priority from JP Application Serial Number 2024-227153, filed Dec. 24, 2024, the disclosure of which is hereby incorporated by reference herein in its entirety.

### BACKGROUND

### 1. Technical Field

The present disclosure relates to a liquid discharging head that discharges a liquid.

### 2. Related Art

As disclosed in JP-A-2013-158909, a technique of a liquid discharging head that discharges a liquid from a nozzle by applying pressure fluctuation to a liquid in a pressure chamber is known. The pressure fluctuation is generated by driving an actuator formed at a vibration plate forming one surface of the pressure chamber. As the actuator, a piezoelectric element in which electrodes are provided on both sides of the piezoelectric layer is used. When a voltage signal is applied between the electrodes that interpose the piezoelectric layer, the piezoelectric element is deformed, and the deformation causes pressure fluctuation in the pressure chamber via the vibration plate.

When the vibration plate is vibrated due to deformation of the piezoelectric element, the stress generated by the vibration may act on the vibration plate, and a problem such as a crack may occur in the vibration plate. Therefore, as disclosed in JP-A-2019-111738, a recess is provided at a section of the vibration plate in which stress is concentrated, and it is proposed to prevent damage due to concentration of stress. The technique of JP-A-2019-111738 is excellent in improving the reliability of the vibration plate, but it is necessary to process the vibration plate. Therefore, a configuration which is easy to be manufactured and in which the reliability of the pressure chamber including the vibration plate is improved is desired.

### SUMMARY

According to an aspect of the present disclosure, there is provided a liquid discharging head. A liquid discharging head includes a pressure chamber substrate that has a pressure chamber space partitioned by side walls, a vibration plate that overlaps the pressure chamber substrate and covers the pressure chamber space to form one surface of a pressure chamber, a piezoelectric element that is formed on the vibration plate, and in which a lower electrode, a piezoelectric layer, and an upper electrode are stacked in a thickness direction of the pressure chamber space formation vibration plate as a stacking direction, and a protective film that is provided on the piezoelectric element. Here, a protruding portion is provided that is formed toward an inside of the pressure chamber space is provided with respect to a surface of the side wall as a reference at a coupling section where at least one of the side walls present in the first direction which is the longitudinal direction of the pressure chamber space is in contact with the vibration plate, and, when the pressure chamber is viewed in plan view, the protective film is provided from the outside to the inside of the pressure chamber up to a position that covers at least the protruding portion.

### BRIEF DESCRIPTION OF THE DRAWINGS

FIG. 1 is a perspective view for explaining a configuration of a printer including a liquid discharging head according to an embodiment.

FIG. 2 is a partially exploded perspective view of the liquid discharging head.

FIG. 3 is an explanatory diagram for explaining details of a pressure chamber and a flow path.

FIG. 4 is a schematic view illustrating a configuration of a main portion of the liquid discharging head taken along a cross section along a longitudinal direction of the pressure chamber.

FIG. 5 is a cross-sectional view taken along line V-V in FIG. 4.

FIG. 6 is an explanatory diagram illustrating the liquid discharging head viewed in plan view from a vibration plate side that is overlapped with one surface of the pressure chamber.

FIG. 7 is an explanatory diagram schematically illustrating a form of a protruding portion present on a side wall of the pressure chamber.

FIG. 8 is a cross-sectional view taken along line VIII-VIII in FIG. 7.

FIG. 9 is an explanatory diagram illustrating a positional relationship between a stress relaxation film which is a first protective film and each portion in plan view.

FIG. 10 is an explanatory diagram illustrating a positional relationship between a protruding portion, which is provided at a coupling location between the pressure chamber and the flow path, and a protective film.

FIG. 11 is an explanatory diagram illustrating a disposition of a second protective film formed at a first protective film in a liquid discharging head of a second embodiment.

FIG. 12 is an explanatory diagram illustrating a formation procedure of a protective film.

FIG. 13 is an explanatory diagram illustrating a relationship between a first protective film and a second protective film in a liquid discharging head of a third embodiment, and a hillock density.

FIG. 14 is an explanatory diagram illustrating a configuration around a pressure chamber of a fourth embodiment in plan view.

FIG. 15 is a sectional explanatory diagram illustrating a configuration around a pressure chamber of a fourth embodiment.

FIG. 16 is an explanatory diagram illustrating a positional relationship between the active portion and the corner portion and the side wall.

FIG. 17 is an explanatory diagram illustrating a configuration in which the pressure chamber and the nozzle are coupled via a communication substrate.

### DESCRIPTION OF EMBODIMENTS

### A. First Embodiment

Hereinafter, aspects for carrying out the present disclosure will be described with reference to the drawings. In embodiments described hereinafter, although various limitations are made as favorable specific examples of the present disclosure, the scope of the present disclosure is not limited to these aspects as long as there is no description particularly limiting the present disclosure. For example, in the following description, as an example of a liquid discharging head, an ink jet head that discharges ink and an ink jet printer (hereinafter, a printer) equipped with the ink jet head will be described. However, a liquid to be discharged is not limited to ink, and may be various liquids such as water, alcohol, oil, and medicines, or a suspension in which fine particles such as conductive particles such as pigments and metal powders are suspended in these liquids. In addition, in the present specification, sending out a liquid from a nozzle or the like to the outside is referred to as “discharging”. The discharging includes various aspects in which a predetermined amount of liquid is ejected to the outside, such as ejection, jetting, spraying, discharge, and intermittent discharging, regardless of the type of liquid, the ejecting time, the number of times, and the like.

### A1. Configuration of Printer 1:

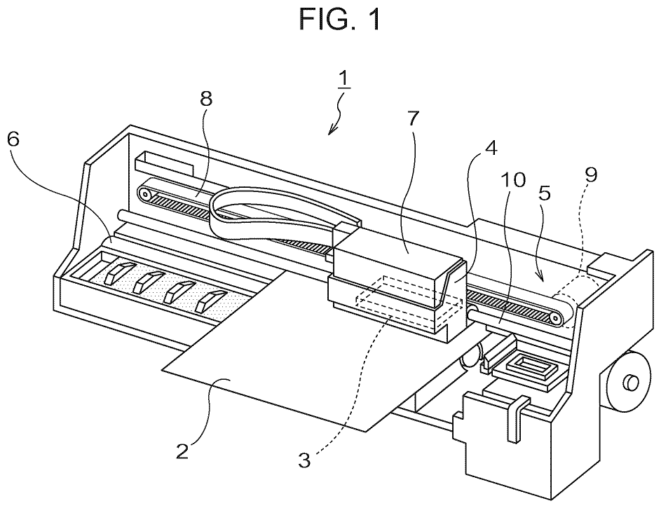

Before describing a liquid discharging head 3, a configuration of a printer 1 will be described with reference to FIG. 1. The printer 1 is a device that performs recording of an image or the like by ejecting a liquid ink onto a surface of a recording medium 2 such as recording paper. The printer 1 includes a liquid discharging head 3, a carriage 4 to which the liquid discharging head 3 is attached, a carriage moving mechanism 5 that moves the carriage 4 in a main scanning direction, a transport mechanism 6 that transfers the recording medium 2 in a sub-scanning direction, and the like. Here, the above-mentioned ink is a type of liquid and is stored in the ink cartridge 7 as a liquid supply source. The ink cartridge 7 is detachably mounted on the liquid discharging head 3. A configuration may be adopted in which the ink cartridge is disposed on the main body side of the printer, and the ink is supplied from the ink cartridge to a recording head through an ink supply tube.

The carriage moving mechanism 5 includes a timing belt 8. The timing belt 8 is driven by a pulse motor 9 such as a DC motor. Therefore, when the pulse motor 9 operates, the carriage 4 is guided by the guide rod 10 erected in the printer 1 and reciprocates in the main scanning direction (width direction of the recording medium 2).

A2. Configuration of Liquid Discharging head:

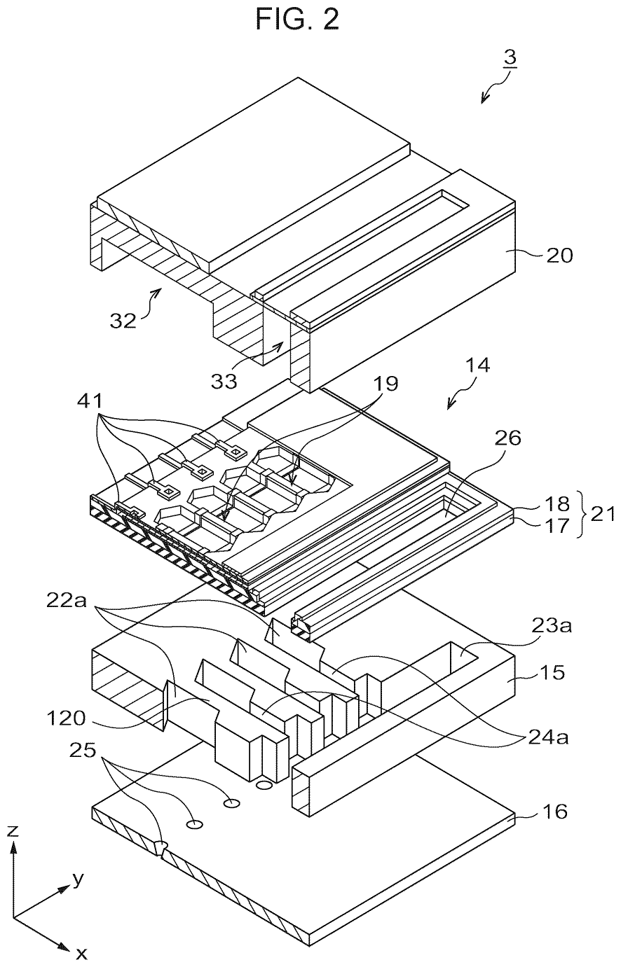

As illustrated in FIG. 2, the liquid discharging head 3 according to the first embodiment is configured by stacking, in order from the lower side, a nozzle plate 16 in which a plurality of nozzles are formed, a pressure chamber substrate 15 in which a pressure chamber space 22a to be described later and the like are formed, an actuator unit 14 having a vibration plate 21 at the bottom portion, and a sealing plate 20 for sealing the actuator unit 14, and the like. As illustrated in the drawing, the stacking direction is referred to as a z direction. In addition, a direction in which a plurality of nozzles 25 provided on the nozzle plate 16 are arranged is referred to as a y direction, and a direction orthogonal to the y direction is referred to as an x direction. In the present specification, the x direction may be referred to as a first direction, and the y direction may be referred to as a second direction. Each of the directions xyz is also appropriately described in other drawings.

The pressure chamber substrate 15 is, for example, a plate material made of a silicon single crystal substrate or the like. The pressure chamber substrate 15 is formed with a plurality of pressure chamber spaces 22a, a plurality of flow path spaces 24a, and a communication portion space 23a. The plurality of pressure chamber spaces 22a and the flow path spaces 24a are provided in parallel with the partition walls 120 interposed therebetween. Each of the pressure chamber spaces 22a and each of the flow path spaces 24a are coupled to each other. Furthermore, the plurality of flow path spaces 24a are commonly coupled to the communication portion space 23a.

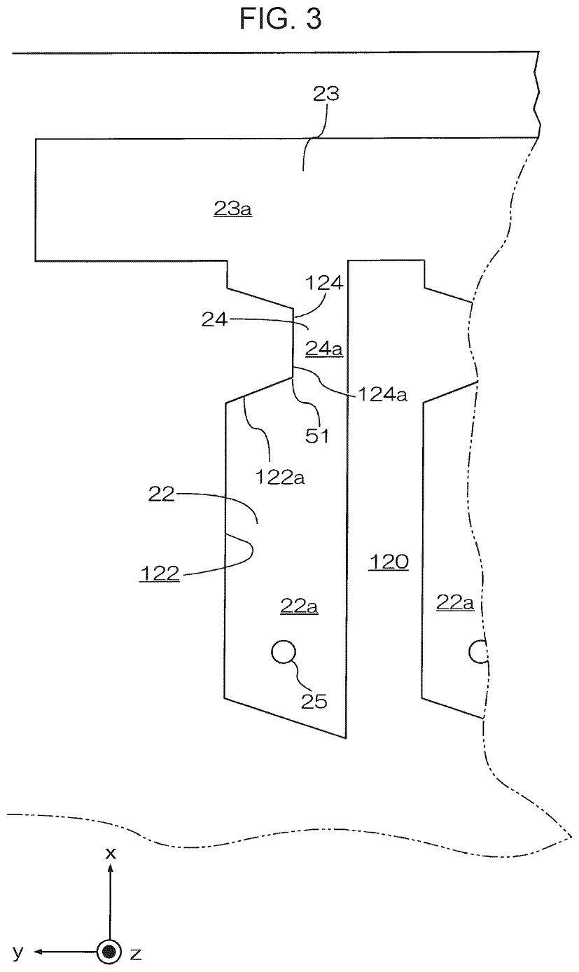

The partition walls 120 separate the plurality of pressure chamber spaces 22a and the flow path spaces 24a. The pressure chamber space 22a and the flow path space 24a are stacked with the nozzle plate 16 and the vibration plate 21 to form a pressure chamber 22 and a flow path 24, respectively. Similarly, the communication portion space 23a forms a communication portion 23. These relationships will be described in detail with reference to FIG. 3. As illustrated in the drawing, a partition wall 120 is present between the adjacent pressure chambers 22 and flow paths 24, and the side surface of the partition wall 120 functions as a side wall for the pressure chamber 22 and the flow path 24, the side surface being the side surface in the x and y directions and the reverse directions thereof illustrated in the drawing. Among these side walls, the side wall that forms the pressure chamber 22 is referred to as a pressure chamber side wall 122, and the side wall that forms the flow path 24 is referred to as a flow path side wall 124. Unless otherwise specified, the x direction indicates the direction from the pressure chamber space 22a to the flow path space 24a as illustrated in the drawing, and, when a direction opposite to the x direction is specified, the direction may be referred to as a −x direction. Similarly, when specifying the direction opposite to the direction illustrated in the drawing, the y direction and the z direction are respectively described as a −y direction and a −z direction.

The pressure chamber 22 is a pressure chamber space 22a surrounded by the pressure chamber side wall 122, and is surrounded at the bottom by the nozzle plate 16 and at the top by the vibration plate 21. Similarly, the flow path 24 is the flow path space 24a surrounded by the flow path side wall 124, and is surrounded by the nozzle plate 16 at the bottom and the vibration plate 21 at the top. The plurality of flow paths 24 are coupled to the communication portion 23, and when the liquid discharging head 3 is used, the spaces are filled with ink. In the following description, the pressure chamber 22 and the pressure chamber space 22a are referred to as the pressure chamber 22 when it is not necessary to particularly distinguish therebetween. The same applies to the flow path 24 and the communication portion 23.

In the present embodiment, the pressure chamber space 22a has a substantially trapezoidal shape when viewed in plan view in the z direction, and is surrounded by the four pressure chamber side walls 122. Among the four pressure chamber side walls 122, the side wall that forms the corner portion 51 together with the flow path side wall 124 on the flow path 24 side is referred to as a first pressure chamber side wall 122a as a side wall on the pressure chamber side, and may be distinguished from the other side walls. Similarly, the side wall on the flow path 24 side that forms the corner portion 51 together with the first pressure chamber side wall 122a may be referred to as a first flow path side wall 124a to be distinguished from the other side walls.

The partition wall 120 of the pressure chamber substrate 15 partitions the pressure chamber 22 as the pressure chamber side wall 122, partitions the flow path 24 as the flow path side wall 124, and the side walls form a corner portion 51 at a coupling location where the pressure chamber 22 and the flow path 24 are coupled. Therefore, the corner portion 51 is a section in which the two side walls protrude to the pressure chamber 22 side or the flow path 24 side, that is, to the outside when viewed from the partition wall 120. In this case, the first pressure chamber side wall 122a and the first flow path side wall 124a form an angle larger than 180 degrees. Naturally, the corner portion 51 is not limited to the one formed by the two adjacent side walls, and may be provided as a bent portion that is bent so that the side wall that couples the pressure chamber 22 and the flow path 24 protrudes to the outside. The corner portion 51 may be a pin corner sharpened to a manufacturing limit, or may have a predetermined chamfer or a curved surface (R).

The pressure chamber 22 is a long space in the first direction, and is provided to correspond to each of the nozzles 25 of the nozzle plate 16. That is, each pressure chamber 22 is formed at the same pitch as the formation pitch of the nozzle 25 along a nozzle row direction. The pressure chamber substrate 15 of the present embodiment is created by anisotropically etching a silicon single crystal substrate having a (110) plane orientation. Therefore, the upper opening (opening on the side opposite to the nozzle 25 side) of the pressure chamber 22 has a trapezoidal shape. An example of the dimensions of the pressure chamber 22 is as follows, but the present disclosure is not limited thereto. The dimension of the upper opening of the pressure chamber 22 in the first direction (x direction) is set to substantially 360 μm, the width of the upper opening of the pressure chamber 22, that is, the dimension in the second direction (y direction) is set to substantially 70 μm, and the height of the pressure chamber in the z direction, that is, the thickness of the pressure chamber substrate 15 is set to substantially 70 μm, respectively. The dimension of the upper opening of the pressure chamber 22 in the first direction (x direction) may be set to substantially 300 to 2000 μm, the dimension of the width of the upper opening of the pressure chamber 22 may be set to substantially 20 to 200 μm, and the height of the pressure chamber in the z direction may be set to substantially 30 to 200 μm.

As illustrated in FIG. 2, in the pressure chamber substrate 15, in an area separated from the flow path space 24a in the x direction, the communication portion space 23a penetrating the pressure chamber substrate 15 is formed along the direction in which the pressure chamber spaces 22a are provided. The communication portion 23 formed by the communication portion spaces 23a is a space portion common to each pressure chamber 22 and each flow path 24. The communication portion 23 and each pressure chamber 22 are communicated with each other through the flow path 24. The communication portion 23 communicates with a communication opening portion 26 of the vibration plate 21 and a liquid chamber empty portion 33 of the sealing plate 20, which will be described later, to configure a reservoir (common liquid chamber) which is a common ink chamber for each pressure chamber 22. The flow path space 24a is formed with a width narrower than that of the pressure chamber space 22a, and the flow path 24 serves as a flow path resistance with respect to the ink flowing from the communication portion 23 to the pressure chamber 22.

The pressure chamber substrate 15 and the nozzle plate 16 are bonded to each other via an adhesive, a heat welding film, or the like. In the present embodiment, the nozzles 25 are arranged side by side at a pitch (center distance between adjacent nozzles 25) corresponding to a dot formation density (for example, 300 dpi) on the nozzle plate 16. Each nozzle 25 communicates with the pressure chamber 22 at an end portion opposite to the flow path 24. The nozzle plate 16 is formed of, for example, glass ceramics, a silicon single crystal substrate, a polyimide-based photosensitive resin, stainless steel, or the like.

In the actuator unit 14 stacked on the pressure chamber substrate 15, a plurality of piezoelectric elements 19 corresponding to the respective pressure chambers 22 are provided on the upper surface of the vibration plate 21 configuring the upper surface of the pressure chamber 22 in the z direction, that is, on the side of the vibration plate 21 opposite to the pressure chamber 22. The vibration plate 21 includes an elastic film 17 on the pressure chamber substrate 15 side and an insulator film 18 formed at the elastic film 17. As the elastic film 17, for example, silicon dioxide (SiO₂) having a thickness of 300 to 2000 nm is suitably used. In addition, as the insulator film 18, for example, zirconium oxide (ZrOₓ) having a thickness of 30 to 600 nm is suitably used. A portion of the vibration plate 21 corresponding to the pressure chamber 22, that is, a portion that blocks the upper opening of the pressure chamber space 22a and partitions a part of the pressure chamber 22 functions as a displacement portion that is displaced in a direction away from or in a direction close to the nozzle 25 with the bending deformation of the piezoelectric element 19. A communication opening portion 26 communicating with the communication portion 23 is provided in a portion of the vibration plate 21 corresponding to the communication portion 23 of the pressure chamber substrate 15.

### A3. Configuration of Piezoelectric Element:

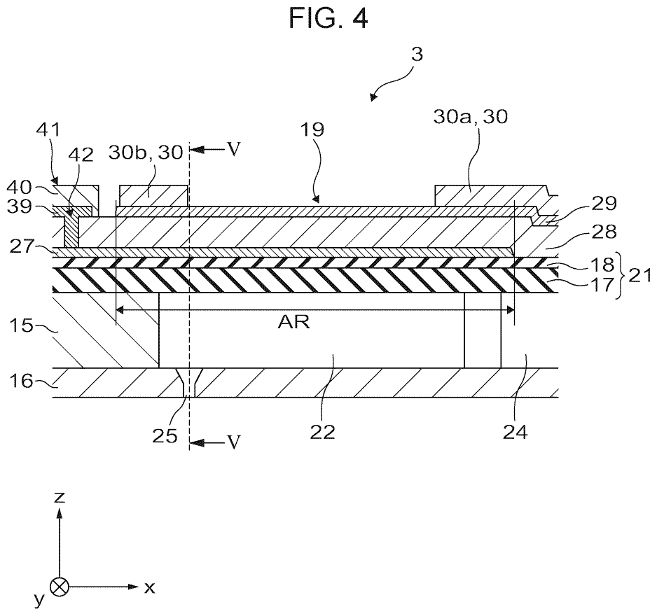

Next, the structure of the piezoelectric element 19 formed in the actuator unit 14 will be described with reference to FIGS. 4 to 6. In the present embodiment, the piezoelectric element 19 is formed by sequentially stacking a lower electrode 27, a piezoelectric layer 28, and an upper electrode 29 from the vibration plate 21 side by a film forming technique. As the upper electrode 29 and the lower electrode 27, various metals such as iridium (Ir), platinum (Pt), titanium (Ti), tungsten (W), tantalum (Ta), and molybdenum (Mo), and alloys thereof are used. In addition, as the piezoelectric layer 28, a ferroelectric piezoelectric material such as lead zirconate titanate (PZT) or a relaxor ferroelectric to which a metal such as niobium, nickel, magnesium, bismuth, or yttrium is added is used.

An example of the thickness of each layer is illustrated below. The thickness of the upper electrode 29 can be set in the range of 15 to 100 nm, the thickness of the piezoelectric layer 28 (specifically, the thickness of the piezoelectric layer 28 in the portion interposed between the upper electrode 29 and the lower electrode 27) can be set in the range of 0.7 to 5 μm, and the thickness of the lower electrode 27 can be set in the range of 50 to 300 nm. Naturally, the appropriate dimensions may be set according to the materials used in each portion and the functions to be realized. The thickness of each portion of the piezoelectric element 19 will be described in detail later including the thickness of the protective film described later.

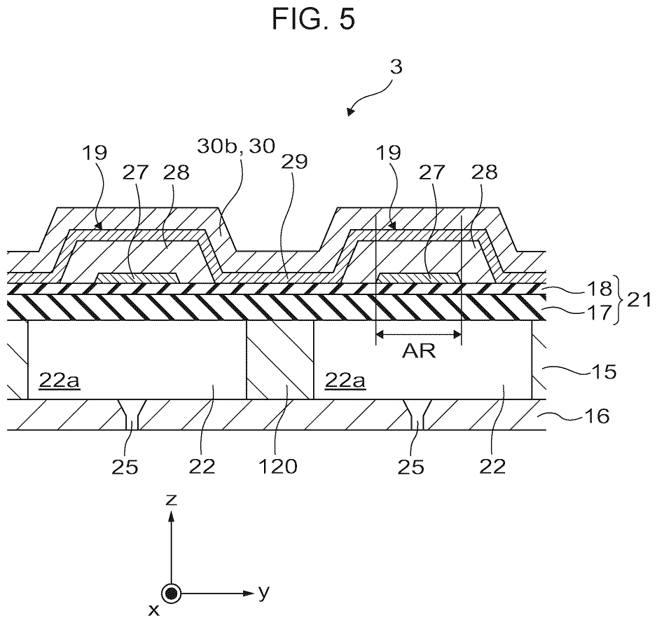

In the present embodiment, as illustrated in FIG. 5, the lower electrode 27 is provided independently for each individual pressure chamber 22, and the upper electrode 29 is continuously provided over the plurality of pressure chambers 22. Therefore, the lower electrode 27 is an individual electrode for each pressure chamber 22, and the upper electrode 29 is a common electrode common to each pressure chamber 22.

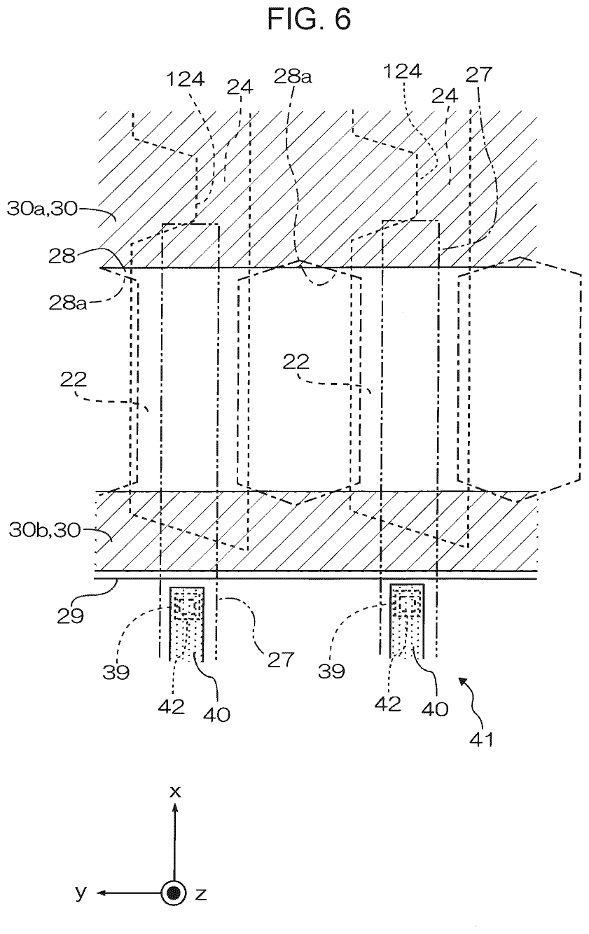

As illustrated in FIGS. 5 and 6, in the second direction (y direction), the width of the lower electrode 27 is formed to be narrower than the width of the pressure chamber 22 (specifically, the upper opening of the pressure chamber space 22a) and the width of the piezoelectric layer 28 (distance between the adjacent opening portions 28a (described later)) in the region corresponding to the pressure chamber 22. As illustrated in FIG. 6, in the first direction (x direction) which is the longitudinal direction of the pressure chamber 22, the lower electrode 27 has a portion in which an end portion on the flow path 24 side overlaps a part of the side wall 122 configuring the end portion of the pressure chamber 22 in plan view (viewed in the −z direction). In other words, the end portion of the lower electrode 27 on the flow path 24 side does not overlap the flow path 24. The overlapping state between the lower electrode 27 and the side wall 122 and another overlapping method will be described in detail later. On the other hand, the end portion of the lower electrode 27 on the other side (−x direction) is extended to a lead electrode portion 41 as illustrated in FIG. 4.

The upper electrode 29 extends to the outside of a group of pressure chambers 22 both end portions of which are arranged side by side in the second direction (y direction). In addition, as illustrated in FIG. 4, the upper electrode 29 has one end portion extending beyond the end portion of the lower electrode 27 to the outside in the first direction (x direction) which is the longitudinal direction of the pressure chamber 22, and the other end portion (−x direction) extending beyond the end portion of the pressure chamber 22 to a region between the pressure chamber 22 and the lead electrode portion 41.

The piezoelectric layer 28 that is stacked by being interposed between the upper electrode 29 and the lower electrode 27 extends to the outside beyond both end portions of the pressure chamber 22 in the longitudinal direction, and is formed over the plurality of pressure chambers 22. A plurality of opening portions 28a in which the piezoelectric layer 28 is partially removed are formed in regions corresponding to spaces between the adjacent pressure chambers 22. That is, the plurality of opening portions 28a are formed along the second direction (y direction) which is the nozzle row direction at the same pitch as the formation pitch of the pressure chambers 22 (the formation pitch of the nozzles 25). In other words, the piezoelectric element 19 corresponding to one pressure chamber 22 is formed between the opening portion 28a and the opening portion 28a at the same pitch as the formation pitch of the pressure chambers 22. The width of the piezoelectric layer 28 in the nozzle row direction (distance between the adjacent opening portions 28a) on the pressure chamber space is formed to be narrower than the width of the pressure chamber 22 in the same direction and wider than the width of the lower electrode 27 in the same direction. Further, the length of the opening portion 28a in the longitudinal direction is formed to be shorter than the length of the pressure chamber 22 in the longitudinal direction (x direction) as illustrated in FIG. 6. That is, in the longitudinal direction, all the end portions on both sides of the opening portion 28a are positioned inside (the center side of the pressure chamber 22) than the end portions on both of the sides of the pressure chamber 22. In addition, the opening portions 28a of the present embodiment are formed in an elongated hexagonal shape along the longitudinal direction of the pressure chamber 22 in plan view. In addition, in the longitudinal direction of the pressure chamber 22, the piezoelectric layer 28 in the region separated from the opening portions 28a is continuously formed over the plurality of pressure chambers 22.

As illustrated in FIG. 5, the width (dimension in the y direction) of each portion of the piezoelectric element 19 is smaller in the order of the width of the upper electrode 29, the width of the pressure chamber 22, the width of the piezoelectric layer 28, and the width of the lower electrode 27 in the region corresponding to the pressure chamber 22. In the piezoelectric layer 28, a region interposed between the lower electrode 27 and the upper electrode 29 is distorted and causes displacement in the piezoelectric element 19 when a voltage is applied between the two electrodes. This range is referred to as an active portion AR. As illustrated in FIGS. 4 and 5, the active portion AR is a range where the upper electrode 29 and the lower electrode 27 overlap in the first direction (x direction), and substantially coincides with the width of the lower electrode 27 in the second direction (y direction).

As described above, the opening portion 28a corresponds to a first region in which the piezoelectric layer 28 does not exist and the lower electrode 27 does not exist. Therefore, the opening portion 28a functions as an arm portion that facilitates the deformation of the vibration plate 21 when the active portion AR of the piezoelectric element 19 is driven by a drive signal, although the upper electrode 29 is present on the vibration plate 21.

A protective film 30 that is continuous over the plurality of pressure chambers 22 is stacked in an end portion region of the piezoelectric element 19 in the first direction (x direction) that is the longitudinal direction of the pressure chamber 22. The protective film 30 is provided at both end portions of the piezoelectric element 19, and when distinguishing both, the protective film 30 that is formed in the first direction (x direction), that is, in the end portion region on the flow path 24 side is referred to as a protective film 30a, and the protective film 30 that is formed in the end portion region on the opposite side is referred to as a protective film 30b. The stress relaxation films 30a and 30b are metal films (for example, NiCr) and are stacked on the upper electrode 29. In the present embodiment, the stress relaxation film 30 is continuously formed over the plurality of pressure chambers 22 and is formed at both sides of the opening portions 28a in the first direction (x direction). As will be described later, the protective film 30 may be formed by stacking two types of films. That is, the protective layer 30 may be configured to include the stress relaxation films 30a and 30b corresponding to the first protective film and a restriction film 30c corresponding to the second protective film stacked on the stress relaxation films 30a and 30b (in the z direction). The configuration, material, and the like of the protective film 30 will be described in detail in a second embodiment.

The stress relaxation film 30a formed at the flow path 24 side extends from a region outside of the pressure chamber 22 and the flow path 24 to a region corresponding to the end portion of the opening portion 28a. On the other hand, the same stress relaxation film 30b is provided on the opposite side (nozzle 25 side) of the piezoelectric element 19 in the first direction (x direction). The stress relaxation film 30b extends from a region corresponding to the end portion on the other side of the opening portion 28a to a region between the pressure chamber 22 and the lead electrode portion 41 beyond the end portion of the pressure chamber 22. The restriction layer 30c that restricts the displacement of the piezoelectric element 19 may be provided above the stress relaxation film 30b.

As illustrated in FIG. 6, the stress relaxation film 30a has one side that overlaps an end portion including an opening portion 28a having a vertex of the elongated hexagonal shape in plan view, and overlaps an end portion including a boundary with the flow path 24 of the pressure chamber 22. Further, the stress relaxation film 30b has the other side that overlaps an end portion including a vertex on the other side of the opening portion 28a in plan view, and overlaps the end portion on the other side of the pressure chamber 22. When the stress relaxation film 30a overlaps the opening portion 28a in the first direction (x direction) which is the longitudinal direction of the pressure chamber 22, the rigidity of the piezoelectric element 19 in the region corresponding to the end portion of the pressure chamber 22 is increased without excessively suppressing the deformation of the piezoelectric element 19.

Electricity is supplied to the lower electrode 27 that is individually formed for each pressure chamber 22 via the lead electrode portion 41. As illustrated in FIGS. 4 and 6, the lead electrode portion 41 is formed at a position outside the end portion of the pressure chamber 22 on the nozzle 25 side and outside the stress relaxation film 30b. The lead electrode portion 41 is formed in a state where a through-hole 42 from the upper surface of the piezoelectric layer 28 to the lower electrode 27 penetrates the piezoelectric layer 28. A conductive upper electrode film 39 is formed to be slightly larger than the through-hole 42 in a region corresponding to the through-hole 42. The conductive upper electrode film 39 is individually patterned corresponding to the through-hole 42, and is conductive to the lower electrode 27 which is an individual electrode through the through hole 42. In addition, an individual metal layer 40 is patterned to correspond to the lower electrode 27 (through hole 42) on the conductive upper electrode film 39. With such a structure, the individual metal layer 40 is conductive to the lower electrode 27 via the conductive upper electrode film 39 formed in the region corresponding to the through-hole 42. The individual metal layer 40 (lead electrode portion 41) extends to a terminal region (not illustrated) and is electrically coupled to an individual electrode terminal of a wiring member. The lower electrode 27 is covered with the piezoelectric layer 28 except for a range facing the through-hole 42. As a result, leakage current from the lower electrode 27 is suppressed as much as possible, and it is possible to save the trouble of taking a special measure (for example, protection by a protective film such as aluminum oxide) for suppressing the leakage current. Naturally, the protective film may be provided.

As illustrated in FIG. 2, the actuator unit 14 is bonded to the pressure chamber substrate 15 in the lower side (−z direction), and is bonded to the sealing plate 20 having an accommodation space portion 32 that can accommodate the piezoelectric element 19 in the upper side (z direction). The sealing plate 20 is provided with the liquid chamber empty portion 33 at a position outside the accommodation space portion 32 in the x direction, that is, in a region corresponding to the communication opening portion 26 of the vibration plate 21 and the communication portion 23 of the pressure chamber substrate 15. The liquid chamber empty portion 33 penetrates the sealing plate 20 in the thickness direction and is provided along the pressure chamber 22 in the parallel direction (y direction). As described above, the liquid chamber empty portion 33 communicates with the communication opening portion 26 and the communication portion 23 in series to form a reservoir that is a common ink chamber for each pressure chamber 22. Although not illustrated, the sealing plate 20 is provided with a wiring opening portion that penetrates the sealing plate 20 in the thickness direction at a position corresponding to the terminal region of the actuator unit 14, in addition to the accommodation space portion 32 and the liquid chamber empty portion 33. The individual metal layer 40 and the stress relaxation film 30 of the terminal region are exposed in the wiring opening portion. The terminal of the wiring member (not illustrated) from a printer main body side is electrically coupled to the exposed portion of the stress relaxation film 30 or the metal layer 40.

In the liquid discharging head 3 having the above configuration, the flow path from the ink cartridge 7 to the liquid chamber empty portion (reservoir) 33, the flow path 24, the pressure chamber 22, and the nozzle 25 is filled with ink. Then, a drive voltage is applied to each of the piezoelectric elements 19 corresponding to the pressure chambers 22 at an appropriate timing by supplying the drive signal from the printer main body side. Since the drive voltage is applied between the lower electrode 27 and the upper electrode 29, an electric field corresponding to the potential difference between both of the electrodes is applied to the piezoelectric element 19, and the piezoelectric element 19 is deformed, and the active portion AR of the piezoelectric element 19 and the vibration plate 21 is displaced. As a result, pressure fluctuation occurs in the pressure chamber 22, and ink is discharged from the nozzle 25. By controlling the pressure fluctuation, an ink interface (meniscus) in the nozzle 25 is controlled, and an ink droplet having an appropriate size is ejected from the nozzle 25 toward the recording medium 2.

### A4. Disposition of Active Portion and Protruding Portion:

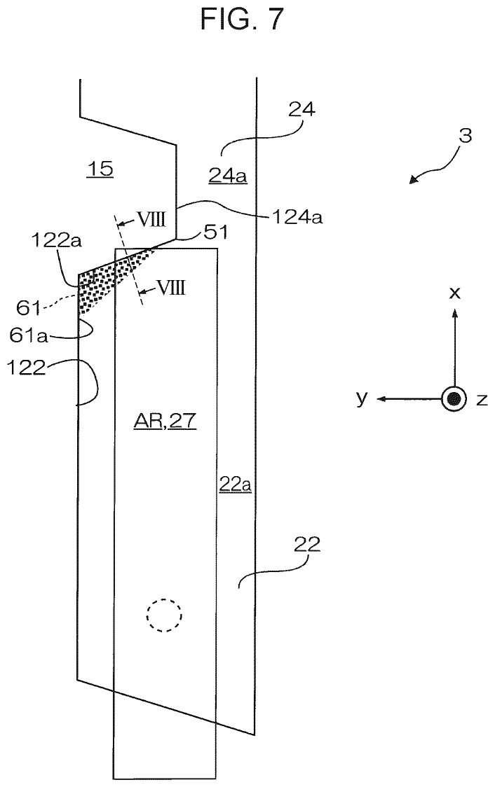

In the liquid discharging head 3 of the present embodiment, the active portion AR, here, the lower electrode 27 that determines the size of the active portion AR is disposed at a specific position with respect to the first pressure chamber side wall 122a of the side wall 122 that partitions the pressure chamber 22. The above point will be described with reference to FIG. 7. FIG. 7 shows the positional relationship between the corner portion 51 provided at the coupling location between the pressure chamber 22 and the flow path 24 and the active portion AR. In the drawing, the vibration plate 21 is not illustrated, and the pressure chamber 22 and the flow path 24 partitioned by the side walls 122 and 124 and the lower electrode 27 are drawn in a superimposed manner. In the present embodiment, as already described, the lower electrode 27 is the smallest in the lower electrode 27, the piezoelectric layer 28, and the upper electrode 29 which are stacked, and the lower electrode 27 and the active portion AR match each other at the end portion on the flow path 24 side. Therefore, in the following description, the disposition of the active portion AR will be described with reference to the lower electrode 27.

As illustrated in the drawing, when the pressure chamber 22 is viewed in plan view, the active portion AR, which is a portion in which the piezoelectric layer 28 is interposed between the lower electrode 27 and the upper electrode 29 in the piezoelectric element 19, here, the lower electrode 27 is disposed at a position which overlaps a part of the first pressure chamber side wall 122a, which is the side wall on the pressure chamber 22 side forming the corner portion 51 at the end portion in the first direction (x direction) which is the longitudinal direction of the piezoelectric element 19, and does not overlap with the corner portion 51. With such a disposition, the lower electrode 27 does not overlap the corner portion 51. Therefore, even when the drive voltage is applied to the piezoelectric element 19 and the piezoelectric element 19 is deformed together with the vibration plate 21, the stress from the lower electrode 27 is not applied to the corner portion 51. Therefore, it is possible to suppress the piezoelectric element 19 from being cracked or a crack from occurring at the section of the corner portion 51.

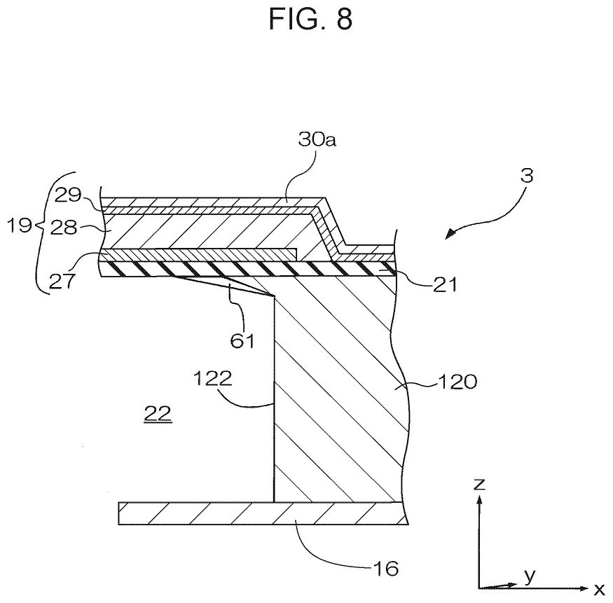

Further, as illustrated in FIG. 7, which is a plan view of the pressure chamber 22 from the vibration plate 21 side that covers the pressure chamber 22, the liquid discharging head 3 includes the protruding portion 61 on the first pressure chamber side wall 122a that partitions the pressure chamber 22 on the flow path 24 side (x direction side). The shape of the protruding portion 61 will be described with reference to FIG. 8, which is a cross-sectional view taken along line VIII-VIII in FIG. 7. The cross section taken along line VIII-VIII is a cross section perpendicular to the first pressure chamber side wall 122a. As illustrated in the drawing, the protruding portion 61 is a portion protruding into the pressure chamber 22 along the surface of the vibration plate 21 at the upper end (z direction end portion) of the first pressure chamber side wall 122a, that is, the end portion that is in contact with the vibration plate 21. With regard to the protruding portion 61, when the pressure chamber substrate 15B is formed by etching a silicon single crystal substrate, the protruding portion 61 may be a part that is intentionally left, or may be formed as a remaining portion generated by the speed at which etching of the corner portion proceeds. By providing the protruding portion 61, the pressure applied to the vibration plate 21 or the piezoelectric layer 28 in the vicinity of the protruding portion 61 can be relaxed.

Moreover, in the present embodiment, when the pressure chamber 22 is viewed in plan view from the vibration plate 21 side, a part of the active portion, here, the end portion of the lower electrode 27 corresponding to the active portion AR on the flow path side (x direction side) overlaps at least a part of the protruding portion 61. In the piezoelectric element 19 of the present embodiment, a part of the end portion of the lower electrode 27 overlaps the protruding portion 61, but since the upper electrode 29 is provided as the common electrode, the piezoelectric layer 28 and the upper electrode 29 cover most of the protruding portion 61. Therefore, the stress applied from the lower electrode 27 corresponding to the active portion AR to the protruding portion 61 can be relaxed, and the occurrence of a situation in which the protruding portion 61 is cracked or fractured can be reduced. Further, since the upper electrode 29, which is the common electrode, widely covers the piezoelectric layer 28, the piezoelectric layer 28 is not exposed to the outside, and the influence of the external environment is unlikely to be received, so that high reliability, durability, and the like can be easily achieved. When the upper electrode 29 is used as the common electrode in this manner, the side wall 122 of the pressure chamber 22 and the like can be covered with the upper electrode 29 made of the same metal material, and it is easy to reduce the variation in the way the stress is applied. Therefore, it is difficult for a gap or the like to be generated in each portion, and it is possible to suppress the possibility that moisture enters the inside of the piezoelectric element 19 from the distance.

In the illustrated embodiment, the thickness of the protruding portion 61 is linearly decreased as being separated from the pressure chamber side wall 122, but the present disclosure is not limited thereto. The thickness may also be a shape that is gradually decreased in a step shape. In this case, the tapering angle of each portion may be defined, for example, as an angle of a straight line connecting a position of the lowermost end where the protruding portion 61 is in contact with the first pressure chamber side wall 122a and a position of the uppermost end where the protruding portion 61 is in contact with the vibration plate 21. Alternatively, the angle of the inclined shape in the vicinity of the midpoint may represent the tapering angle. Naturally, the protruding portion 61 may be formed to have a uniform thickness.

### A5. Structure and Function of Protective Film:

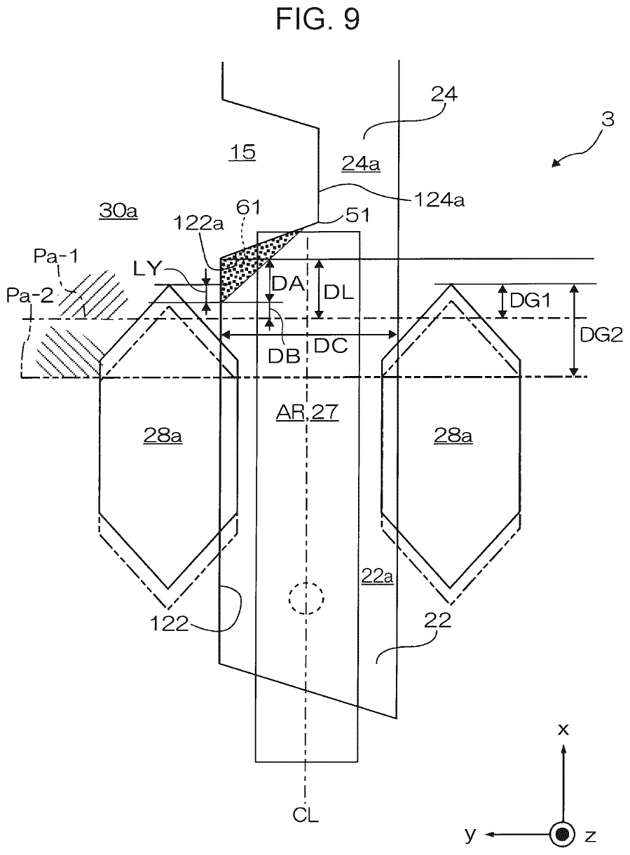

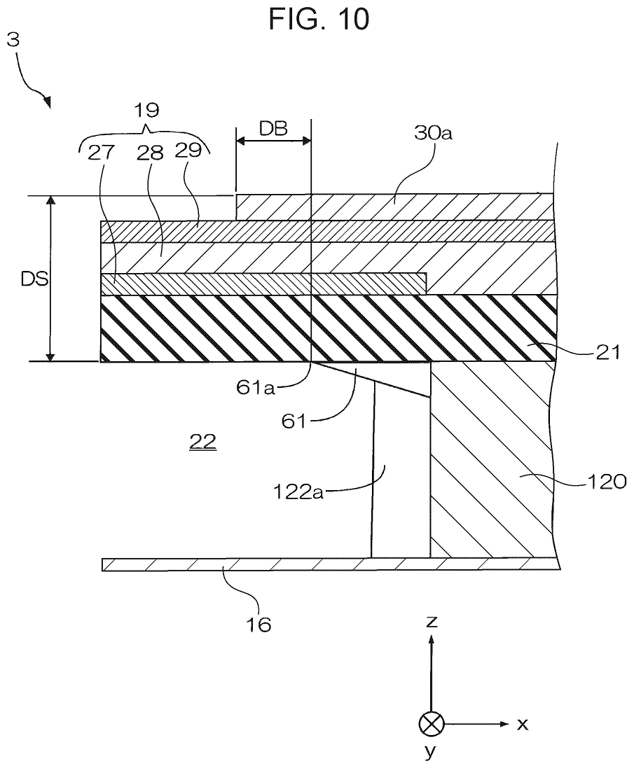

The stress relaxation film 30a provided as the protective film in the present embodiment will be described with reference to FIGS. 9 and 10. FIG. 9 is an explanatory diagram illustrating a positional relationship between the stress relaxation film 30a and each portion in plan view. FIG. 10 is a cross-sectional view illustrating a main portion of the piezoelectric element 19 of the embodiment broken along the longitudinal direction (x direction) at the center CL (refer to FIG. 7) of the lower electrode 27 in the width direction (y direction).

As illustrated in the drawing, in the present embodiment, the stress relaxation film 30a that functions as a protective film covers a part of the vibration plate 21 from the outside to the inside of the pressure chamber 22, and is provided up to a position of covering the protruding portion 61. In FIG. 9, the position covered by the stress relaxation film 30a is a position Pa-1 of one-dot chain line. A position Pa-2 of two-dot chain line will be described later as an example of another feature. The stress relaxation film 30a can be formed of a metal or a non-metal. As the metal, in addition to NiCr used in the present embodiment, as well as, for example, TiW and Pt, various metals such as Ni, Al, Cu, Au, Ti, W, and Ir can be used. In addition, various oxides and nitrides can be used as the non-metal, and, for example, TaOₓ, AlOₓ, SiNₓ, SiO₂, ITO, and, further, TiO₂, ZrO₂, CrOₓ, and the like can also be used.

In the liquid discharging head 3 of the first embodiment described above, the first pressure chamber side wall 122a that is at least one of the side walls existing in the first direction, which is the longitudinal direction of the pressure chamber space 22a, includes the protruding portion 61 that protrudes along the surface of the vibration plate 21 at the end portion in contact with the vibration plate 21. Further, a stress relaxation film 30a, which is a protective film, is provided on a side opposite to the pressure chamber space 22a of the vibration plate 21. The stress relaxation film 30a covers at least a part of the vibration plate 21, and when the pressure chamber 22 is viewed in plan view from the vibration plate 21 side, the stress relaxation film 30a which is a protective film is provided from the outside to the inside of the pressure chamber 22 up to a position covering at least the protruding portion 61.

In the liquid discharging head 3 of the present embodiment is provided with the protruding portion 61, so that it is possible to alleviate the stress applied to the vibration plate 21 in the vicinity of the first pressure chamber side wall 122a, particularly, the elastic film 17. Moreover, even when the protruding portion 61 or the boundary between the protruding portion 61 and the bottom surface of the vibration plate 21 is formed to be thin and has low durability, it is possible to suppress the risk of cracking from the thin section. This is because the stress relaxation film 30a, which is a protective film covering the protruding portion 61, is provided, so that the stress applied to the protruding portion 61 or the boundary between the protruding portion 61 and the vibration plate 21 can be reduced. As a result, it is possible to reduce the risk of occurrence of cracks or fractures in the protruding portion 61 or the boundary.

A6. Other Features that can be Included in Liquid Discharging Head:

### 1. Another Feature 1

In the liquid discharging head 3 of the present embodiment, as illustrated in FIG. 9, when the pressure chamber 22 is viewed in plan view from the vibration plate 21 side, the total length DA of the protrusion along the first direction (x direction) of the protruding portion 61 may be longer than the length DB between the tip end portion of the protruding portion 61 and the terminal Pa-1 of the stress relaxation film 30a. Here, the total length DA of the protruding portion 61 indicates the length of the portion protruding from the first pressure chamber side wall 122a in the direction opposite to the first direction (−x direction).

An example of the total length DA of the protruding portion 61 is 18 μm, and an example of the length DB between the tip end portion of the protruding portion 61 and the terminal Pa-1 of the stress relaxation film 30a is 13 μm. The total length DA of the protruding portion 61 is defined as the length along the direction opposite to the first direction (−x direction) at the farthest end from the corner portion 51 of the first pressure chamber side wall 122a here, but may be defined as the maximum value among the widths protruding from the first pressure chamber side wall 122a in the −x direction. When the protruding portion is present in the other pressure chamber side wall 122 adjacent to the first pressure chamber side wall 122a among all the side walls of the pressure chamber side wall 122, the protruding portion 61 may be regarded as not present in the adjacent pressure chamber side wall 122, and the length of the protrusion from the first pressure chamber side wall 122a may be measured as the total length DA of the protruding portion 61.

In this way, the stress transmitted to the protruding portion 61 due to the displacement of the piezoelectric element 19 to which the drive signal is applied between the electrodes can be relaxed by the stress relaxation film 30a. Further, when the total length DA of the protruding portion 61 is longer than the length DB to the terminal Pa-1 of the stress relaxation film 30a, a region (a part of the length DB) that contributes to the stress relaxation can be secured, and the stress applied to the tip end of the protruding portion 61 can be further reliably relaxed. Naturally, even in a reverse configuration (DA≤DB), it is still possible to relax the stress applied to the tip end of the protruding portion 61.

### 2 Another Feature 2

In the present embodiment, when the pressure chamber 22 is viewed in plan view from the vibration plate 21 side, the length DL from the first pressure chamber side wall 122a in which the protruding portion 61 is present to the tip end portion of the stress relaxation film 30a as a protective film may be shorter than the length DC which is the width of the pressure chamber 22 in the second direction (y direction) intersecting the first direction. In other words, the width DC of the pressure chamber 22 is longer than the length DL, so that the displacement amount of the piezoelectric element 19 in the width direction can be increased. Further, since the length DL covered with the stress relaxation film 30a which is a protective film is shorter than the width DC of the pressure chamber 22, it is possible to secure the displacement of the vibration plate 21 by the piezoelectric element 19 in the pressure chamber 22, and further suppress the occurrence of cracks or fractures in the protruding portion 61. Naturally, even when DL≥DC, the occurrence of cracks or fractures in the protruding portion 61 can be suppressed.

### 3 Another Feature 3:

In addition, as illustrated in FIG. 10, a length DB from the tip end 61a of the protruding portion 61 to the tip end portion of the stress relaxation film 30a which is a protective film may be longer than the sum of the vibration plate 21, the piezoelectric element 19, and the stress relaxation film 30a in the stacking direction (the z direction), that is, the sum of sum DS of the thickness of each of the portions. Here, the thickness of the piezoelectric element 19 is the sum of the thickness of the lower electrode 27, the thickness of the piezoelectric layer 28, and the thickness of the upper electrode 29.

In this way, the displacement of the vibration plate 21 is likely to decrease in the first direction (x direction), so that the stress applied to the protruding portion 61 can be further relaxed, and as a result, the occurrence of cracks or fractures in the protruding portion 61 can be further suppressed. Naturally, even when DB≤DS, the occurrence of cracks or fractures in the protruding portion 61 can be suppressed.

### 4 Another Feature 4

The thickness and elastic characteristics of the stress relaxation film 30a, which is a protective film, for example, a Young's modulus, which is a constant indicating a proportional relationship between stress and deformation, may be as follows. When the thickness of the stress relaxation film 30a, which is a protective film, in the stacking direction is T, its Young's modulus is Ea, the total thickness of the vibration plate 21 and the piezoelectric element 19 is S, and its Young's modulus is Eb, the following inequality [1] may be established therebetween.

$$T \cdot Ea < S \cdot Eb \qquad [ 1 ]$$

The formula [1] indicates that the rigidity of the stress relaxation film 30a, which is a protective film, is lower than the rigidity of the vibration plate 21.

As described above, when the rigidity of the stress relaxation film 30a, which is a protective film, is lower than the rigidity of the vibration plate 21, it is possible to suppress the sharp change in the deflection caused by the piezoelectric element 19 in the vicinity of the stress relaxation film 30a, which is a protective film, and to suppress the concentration of the stress in a narrow range. This is because it is possible to avoid a situation in which the rigidity of the stress relaxation film 30a, which is a protective film, is too high, and it is possible to further suppress the influence of the displacement of the piezoelectric element 19. Naturally, even when T·Ea≥S·Eb, the occurrence of cracks or fractures in the protruding portion 61 can be suppressed.

An example of the material, thickness, Young's modulus, and the like of the piezoelectric element 19 is illustrated in Table 1 below.

TABLE 1

| | | Thickness | Young's | |
|---|---|---|---|---|
| Member | Material | (S) μm | modulus (Eb) | S · Eb |
| Elastic | SiO₂ | Substantially | Substantially | Substantially |
| film | | 1.0 | 100 | 100 |
| Insulator | ZrO₂ | Substantially | Substantially | Substantially |
| film | | 0.6 | 200 | 120 |
| Lower | PT, Ir, Ti | Substantially | Substantially | Substantially |
| electrode | | 0.14 | 200 | 30 |
| Piezoelectric | PZT | Substantially | Substantially | Substantially |
| layer | | 1.2 | 100 | 120 |
| Upper | Ir, Ti | Substantially | Substantially | Substantially |
| electrode | | 0.03 | 200 | 6 |

| Total (S · Eb) | Substantially |
|---|---|
| | 370 |

In addition, an example of the material, thickness, and Young's modulus of the stress relaxation film 30a is illustrated in Table 2 below.

TABLE 2

| | | Thickness | Young's | |
|---|---|---|---|---|
| Member | Material | (T) μm | modulus (Ea) | T · Ea |
| Stress | NiCr | Substantially | Substantially | Substantially |
| relaxation | | 0.06 | 200 | 12 |
| film | | | | |

| Total (T · Ea) | Substantially |
|---|---|
| | 12 |

Therefore, T·Ea<S·Eb and the above-described inequality [1] is satisfied. The above description is an example, and it is desirable that the piezoelectric layer is 1 to 5 μm, the vibration plate (elastic film+insulator film) is 1 to 3 μm, the lower electrode is 0.1 to 0.2 μm, and the upper electrode is 0.05 to 0.15 μm. In addition, when the ratio rE of both is defined by the following equation [2], it is preferable that the rE wave satisfies the following inequality [3].

$$rE = ( T \cdot Ea ) / ( S \cdot Eb ) \qquad [ 2 ]$$

$$0.01 \leq rE \leq 0.04 \qquad [ 3 ]$$

Naturally, the ratio rE of both does not necessarily have to satisfy the above inequality [3].

### 5 Another Feature 5

In the above-described embodiment, the upper electrode 29 is used as a common electrode, but the lower electrode 27 may be used as the common electrode. The configuration in which the lower electrode 27 is used as the common electrode will be described later as a fourth embodiment. When the upper electrode 29 is used as the common electrode, as illustrated in FIGS. 9 and 10, the upper electrode 29 may overlap the protruding portion 61 when the pressure chamber 22 is viewed in plan view from the vibration plate 21 side. When the upper electrode 29 that is continuous as the common electrode in the second direction (y direction) covers the protruding portion 61, the protruding portion 61 is covered with the same material in the width direction (y direction) and the longitudinal direction (x direction). Therefore, it is possible to suppress the variation in the stress applied to the protruding portion 61 depending on the direction.

When a configuration in which the upper electrode 29 is used as a common electrode and covers the protruding portion 61, the opening portion 28a, which is the first region in which the piezoelectric layer 28 is not provided and the upper electrode 29 is provided, can be provided over a predetermined range along the first direction (x direction) on the vibration plate 21 in the second direction (y direction). Since the piezoelectric layer 28 and the lower electrode 27 are not present, the opening portion 28a functions as an arm portion that facilitates the vibration of the vibration plate 21 by the piezoelectric element 19. As described above, the displacement amount of the piezoelectric element 19 can be increased by providing the opening portion 28a, but stress is likely to be concentrated in the opening portion 28a. This is because the piezoelectric element 19 that is displaced by the drive signal is a free end of the vibration, the pressure chamber side wall 122 positioned in the second direction (y direction) of the pressure chamber 22 is a fixed end, and the opening portion 28a is provided between the two. When stress is concentrated at the end portion of the opening portion 28a, a risk occurs that the vibration plate 21 is cracked or fractured at the end portion. However, by adjusting the range in which the stress relaxation film 30a, which is a protective film, is laid, it is possible to reduce such a risk.

As described above, when the laying position of the stress relaxation film 30a is the position Pa-1 and the pressure chamber 22 is viewed in plan view from the vibration plate 21 side, the stress relaxation film 30a, which is a protective film, is provided from the outside to the inside of the pressure chamber 22, and overlaps the tip end portion of the opening portion 28a in the first direction with the width DG1 (refer to FIG. 9). The width of the overlap may be such that the stress relaxation film 30a overlaps only with the tapered tip end portion of the opening portion 28a, or for example, as illustrated by the two-dot chain line in FIG. 9, the stress relaxation film 30a may be extended to the position Pa-2, and may overlap with the stress relaxation film 30a at a width DG2 wider than the width DG1.

As described above, when the vibration of the vibration plate 21 due to the operation of the piezoelectric element 19 is facilitated by providing the opening portion 28a, the stress relaxation film 30a, which is a protective film, covers a part of the opening portion 28a that functions as the arm portion. Therefore, it is possible to suppress the occurrence of cracks, fractures, or the like at the tip end portion of the opening portion 28a. The degree of overlapping may be determined based on the magnitude of the generated stress, the discharge amount of the liquid discharged from the nozzle 25 due to the displacement of the vibration plate 21, and the like. Since the piezoelectric layer 28 and the lower electrode 27 are not present in the opening portion 28a, the amplitude (deflection amount) of the vibration becomes large. Since the stress due to the deflection can be treated as a second-order differential value of the deflection amount, the range in which cracks, fractures, or the like are unlikely to occur in the vibration plate 21, the piezoelectric layer 28, or the like was obtained based on actual measurement. As a result, for example, when the pressure chamber is viewed in plan view, it is found that the width of the overlap between the stress relaxation film 30a and the opening portion 28a, which is the first region, along the first direction (x direction) is preferably in the range of at least 6.2 μm and at most 16.2 μm. Of course, even outside this range, the occurrence of cracks or fractures can be suppressed.

### 6 Another Feature 6

As described above, the stress relaxation film 30a which is a protective film is provided from the outside to the inside of the pressure chamber 22 up to a position covering at least the protruding portion 61, and the stress relaxation film 30a can also overlap at least the tapered tip end portion of the opening portion 28a. Here, a configuration can be provided in which, with regard to the protruding portion 61 and the opening portion 28a which are covered together by the stress relaxation film 30a, when the pressure chamber 22 is viewed in plan view from the vibration plate 21 side, as illustrated in FIG. 9, the protruding portion 61 can be configured not to overlap the tip of the opening portion 28a in the x direction. In this way, when the piezoelectric element 19 is driven and the vibration plate 21 vibrates, the opening portion 28a provided as the arm portion that is easily deformed is deformed, and thus it is possible to suppress a situation in which an excessive stress is applied to the protruding portion 61 and the protruding portion 61 is cracked or fractured.

As for this feature, that is, the configuration in which the protruding portion 61 does not overlap the tip end of the opening portion 28a in the x direction includes not only a positional relationship in which the two portions do not directly overlap each other in plan view as illustrated in FIG. 9, but also a positional relationship in which the two portions are separated from each other in the x direction but overlap each other when viewed in the y direction. In the illustrated example, in a range LY, the protruding portion 61 and the opening portion 28a are in a positional relationship of overlapping with each other when viewed in the y direction. The fact that the protruding portion 61 is provided at a position overlapping the tip end of the opening portion 28a in the y direction in the x direction means that, in other words, when the range of values that the protruding portion 61 can take on the x-axis is compared with the range of values that the opening portion 28a can take on the x-axis are compared in the x-y plane in which the protruding portion 61 and the opening portion 28a are viewed in plan view along the −z direction, it can be said that a range is present in which the values are the same.

The position of the opening portion 28a with respect to the protruding portion 61 may vary due to an error caused by manufacturing. Due to the variation, the distance between the tip end of the opening portion 28a and the protruding portion 61 may be shortened. When the distance between the opening portion 28a and the protruding portion 61 is reduced due to variations in manufacturing, the possibility of cracks or fractures occurring at the tip of the opening portion 28a or the protruding portion 61 is increased. At this time, for example, as illustrated by the two-dot chain line in FIG. 9, when the opening portion 28a is provided at a position that does not overlap the protruding portion 61 even when being viewed in the y direction, it is possible to further suppress the occurrence of cracks or fractures at the tip of the opening portion 28a or the protruding portion 61 even when the position of the opening portion 28a varies in the x direction or the y direction due to a manufacturing error.

Each of the above-described features 1 to 6 may be independently implemented, or two or more features may be combined and implemented. In addition, the same combinations can be appropriately made in the second embodiment and the like described below.

### B. Second Embodiment

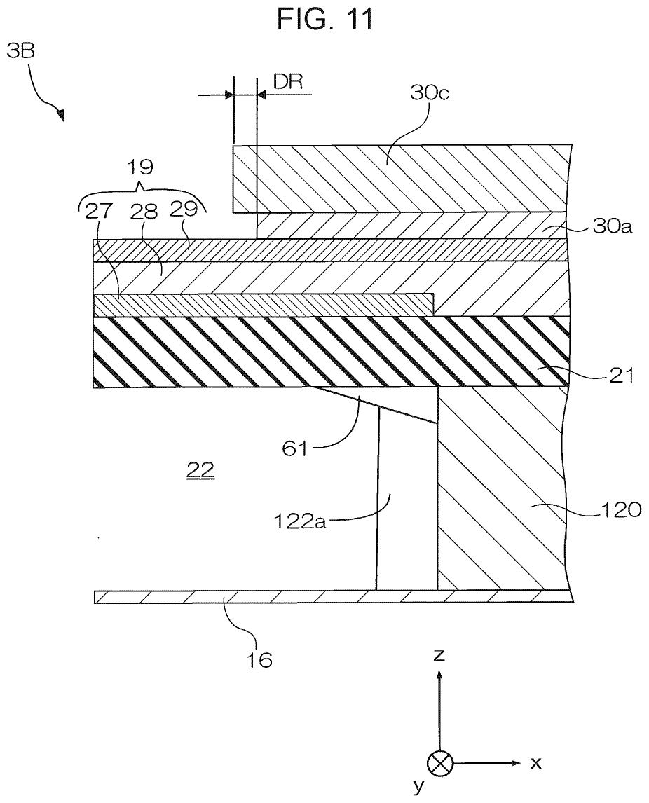

Next, a configuration of a liquid discharging head 3B of a second embodiment will be described. The liquid discharging head 3B of the second embodiment has the same configuration as in the first embodiment except that the protective film has a two-layer structure. FIG. 11 is a cross-sectional view of the liquid discharging head 3B of the second embodiment broken along the longitudinal direction (x direction) at the center CL (refer to FIG. 9) of the lower electrode 27 in the width direction (y direction). As illustrated in the drawing, in the liquid discharging head 3B, as a protective film, a restriction film 30c corresponding to a second protective film is provided above the stress relaxation film 30a corresponding to a first protective film, that is, in a stacking direction (z direction) in which the piezoelectric element 19 is stacked on the vibration plate 21.

In the piezoelectric element 19, in the stacking direction of the lower electrode 27, the piezoelectric layer 28, and the upper electrode 29, the protective film provided above the upper electrode 29 is configured with a stress relaxation film 30a which is a first protective film and a restriction film 30c which is the second protective film having a higher rigidity than the stress relaxation film 30a. The restriction film 30c restricts the displacement of the piezoelectric element 19. As described above, the stress applied to the tip end of the protruding portion 61 can be further relaxed by providing the restriction film 30c which is the second protective film. In the present embodiment, the restriction film 30c is a metal film, which is an Au film here. When the pressure chamber 22 is viewed in plan view in the stacking direction, a part of the tip end portion of the lower electrode 27 overlaps the first pressure chamber side wall 122a and the restriction film 30c. As a result, a part of the lower electrode 27 is interposed between the first pressure chamber side wall 122a, the protruding portion 61, and the restriction film 30c, and thus the displacement of the protruding portion 61 is suppressed when the piezoelectric element 19 is driven. Therefore, it is possible to further reduce the risk of the protruding portion 61 cracking or fracturing.

In the present embodiment, the tip end of the restriction film 30c protrudes by a length DR with respect to the tip end of the stress relaxation film 30a positioned below the restriction film 30c. By adopting such a shape, when the piezoelectric element 19 is displaced to have an upward convex shape, it is possible to suppress the possibility that the restriction film 30c, which is the second protective film, is damaged due to fatigue. When the restriction film 30c is formed at the stress relaxation film 30a by deposition or the like, the range of deposition may be restricted by a mask or the like to form each film.

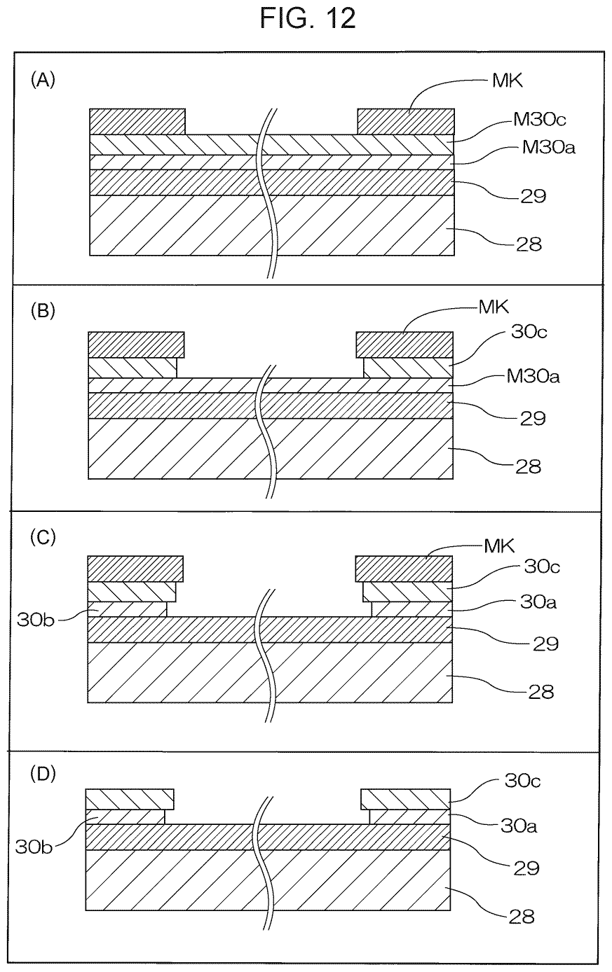

The stress relaxation film 30a and the restriction film 30c can also be formed by etching. A state of film formation in this case is illustrated in FIG. 12. FIG. 12 schematically illustrates an etching procedure. The uppermost stage (A) of FIG. 12 in the drawing illustrates a state where the upper electrode 29, the first film material layer M30a that is the stress relaxation film 30a, and the second film material layer M30c that is the restriction film 30c are stacked on the piezoelectric layer 28, and illustrates a state where a mask MK is formed at the second film material layer M30c to start etching. The first film material layer M30a is a NiCr film, and the second film material layer M30c is an Au film.

When isotropic etching is performed at the second film material layer M30c in this state, as illustrated in (B) of FIG. 12, the region of the second film material layer M30c that is not covered with the mask MK is removed by etching. At this time, since the etching is isotropic, the Au film is also etched in the width direction, and the Au film is removed from the end portion of the mask MK to slightly inside. In this manner, the restriction film 30c is formed.

Next, as illustrated in (C) of FIG. 12, the anisotropic etching is performed at the first material layer M30a by using the formed restriction film 30c as a mask. By this etching, similarly to the etching of the second film material layer 30c, the first film material layer M30a is removed from the end portion of the restriction film 30c to the inside, and the stress relaxation film 30a is formed. Therefore, when the etching is completed and the mask MK is removed, as shown in (D) of FIG. 12, the configuration of the protective film in which the tip of the stress relaxation film 30a is formed in a shape that is recessed by the length DR from the tip of the restriction film 30c is obtained.

### C. Third Embodiment

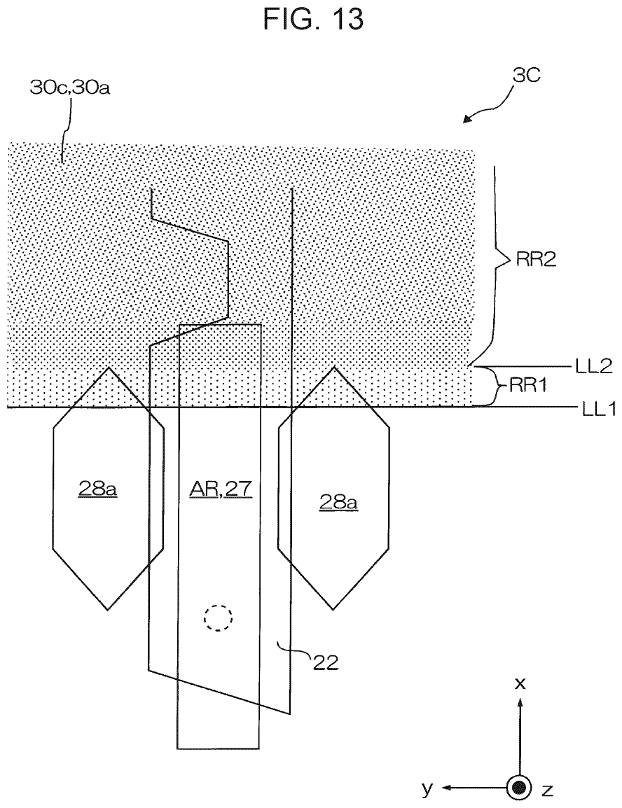

Next, a liquid discharging head 3C of a third embodiment will be described. FIG. 13 is an explanatory diagram illustrating a relationship between the first protective film and the second protective film in the liquid discharging head of the third embodiment, and a hillock density. The liquid discharging head 3C of the third embodiment has the same configuration as in the second embodiment except that the hillock distribution differs due to the overlap between the stress relaxation film 30a and the restriction film 30c. In the present embodiment, as in the second embodiment, the protective film includes the stress relaxation film 30a (NiCr) that is the first protective film provided on the upper electrode 29 with the stacking direction as the vertical direction, and the restriction film 30c (Au) that is the second protective film provided on the first protective film and has higher rigidity than the first protective film. When the pressure chamber 22 is viewed in plan view from the vibration plate 21 side, the stress relaxation film 30a and the restriction film 30c are formed to cover the pressure chamber 22 from the outside of the pressure chamber 22 in the −x direction up to the first position LL1. As illustrated in FIG. 11, a slight difference is present between the positions of the tip ends of the restriction film 30c and the stress relaxation film 30a, but the positions are described as covering up to the same first position LL1.

At this time, the hillock is formed at the restriction film 30c by the reaction between NiCr, which is a material configuring the stress relaxation film 30a, and Au which is a material configuring the restriction film 30c. The number of hillocks formed per unit area, that is, the hillock density decreases toward the tip end of the restriction film 30c. The hillock distribution density p gradually decreases toward the tip end, and the average density ρ1 of hillocks formed in the range RR1 from the second position LL2 to the first position LL1 is lower than the average density ρ2 of hillocks in the range RR2 to the second position LL2. In the tip end portion of the restriction film 30c, the hillock is not substantially formed. In general, when a hillock is present in a portion that relaxes stress, the stress is concentrated on the hillock, so that the possibility that cracks or fractures occur from the hillock as a starting point is increased. However, according to the present embodiment, since the hillock is less likely to occur at the tip end of the opening portion 28a in which the amplitude of vibration is likely to increase when the piezoelectric element 19 is driven, it is possible to suppress the occurrence of cracks or fractures from the hillock as a starting point.

### D. Fourth Embodiment

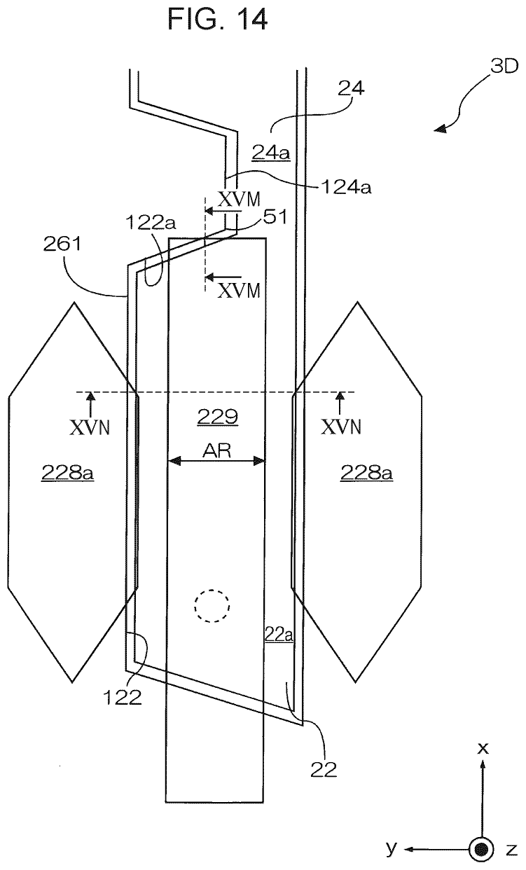

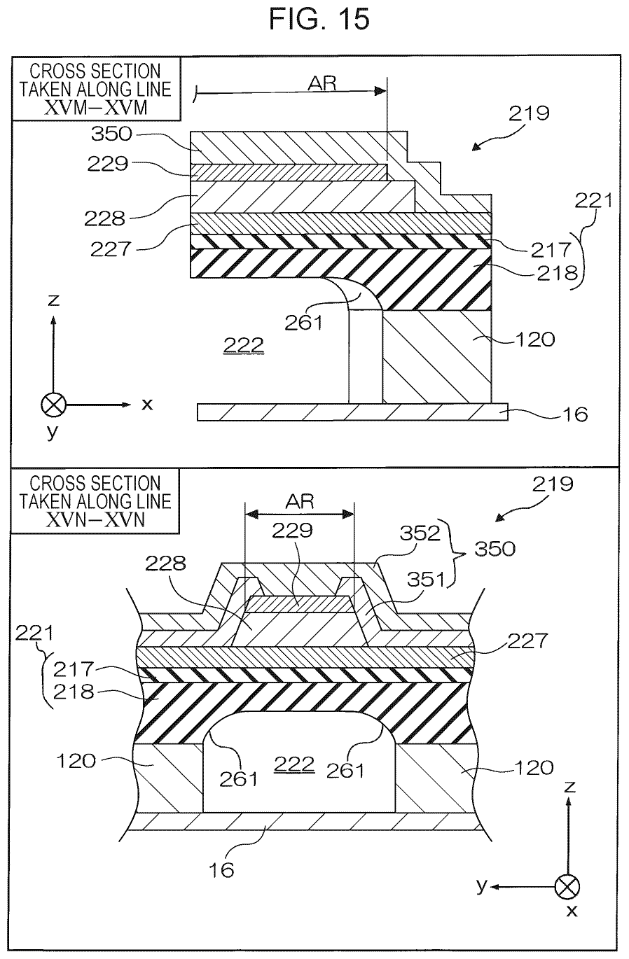

Next, the configuration of a liquid discharging head 3D of a fourth embodiment will be described with reference to FIGS. 14 and 15. FIG. 14 is an explanatory diagram illustrating a configuration around a pressure chamber 222 according to the fourth embodiment in plan view, and FIG. 15 is an explanatory diagram illustrating the configuration around the pressure chamber 222 according to the fourth embodiment by a cross-sectional view taken along line XVM-XVM and line XVN-XVN in FIG. 14. The liquid discharging head 3D of the fourth embodiment is different from the first to third embodiments in that the lower electrode is used as the common electrode instead of the upper electrode, and the pressure chamber 222 is configured with two members in the stacking direction of a piezoelectric element 219.

First, the configuration of the piezoelectric element 219 will be described with reference to FIG. 15. In the liquid discharging head 3D of the fourth embodiment, a lower electrode 227 is used as a common electrode. As illustrated in FIG. 15, on the vibration plate 221 including an elastic film 217 and an insulator film 218, the lower electrode 227 as a common electrode is continuously formed in the second direction (y direction), and an individual piezoelectric layer 228 and an upper electrode 229 are formed thereon. In this example, a protective film 350 made of the stress relaxation film 351 and the restriction film 352 of the metal film is provided to cover the piezoelectric element 219 so that the x-direction end portions of the upper electrode 229 and the piezoelectric layer 228 are not exposed. The end surface of the piezoelectric layer 228 or the upper electrode 229 in the x direction is protected by the protective film 350.

In the piezoelectric element 219 of the present embodiment, in the insulator film 218 and the elastic film 217 that configure the vibration plate 221, the elastic film 217 is formed of silicon dioxide (SiO₂), and has a part that is in contact with the pressure chamber side wall 122 and that is thick in the downward direction. A portion that connects the flat surface portion acting as the elastic film 217 and the pressure chamber side wall 122 (vertical surface) is formed as a pair with the elastic film 217 as an R portion 261 having a predetermined radius. Therefore, the abutting portion between the elastic film 217 and the pressure chamber side wall 122 has a recessed shape when viewed from the pressure chamber 222 side over substantially the entire periphery of the pressure chamber 222. The R portion 261 is an aspect of the protruding portion 61 in the above embodiment.

Therefore, according to FIG. 14, when viewed in plan view from the vibration plate 221 side, the end portion of the active portion AR on the x direction side (the end portion of the upper electrode 229 on the x direction side in the drawing) overlaps the R portion 261, and the protective film 350 is provided from the outside to the inside of the pressure chamber 222 up to a position covering at least the protruding portion 261. Therefore, when the piezoelectric element 219, which is the active portion AR, is driven, the possibility of cracks or fractures occurring at the protruding portion 261 can be reduced by the displacement of the piezoelectric element 219 or the vibration of the vibration plate 221 caused by the displacement.

The protruding portion 61 exemplified in the first embodiment has a cross section in a substantially triangular shape, that is, an inclined shape in which the width of the protrusion linearly increases as the protruding portion approaches the vibration plate 21. However, as illustrated in FIG. 15, the width of the protrusion increases as the protruding portion approaches the vibration plate 221 even when a recessed portion shape including the curved R portion 261 on the pressure chamber side. As described above, the protruding portions 61 and 261 may be formed such that the width of the protrusion increases as the protrusion is made or the thickness of the protruding portions 61 and 261 is reduced, or may be formed to protrude with the same thickness. In addition, the protruding portion 61 may have a thickness that decreases in a step shape. The protruding portions 61 and 261 may have an inclined shape in which the width (thickness) in the z direction at a first point at the end portion of the first pressure chamber side wall 122a on the vibration plate side is larger than the width (thickness) at a second point separated from the first pressure chamber side wall 122a from the first point. In this case, the width (thickness) of the protruding portion at another position separated from the first pressure chamber side wall 122a is not a problem. The fact that the width of the protrusion along the surface of the vibration plates 21 and 221 of the protruding portions 61 and 261 becomes larger as the protruding portions approach the vibration plate includes a relationship that the envelope obtained when the width of the protrusion of the protruding portions 61 and 261 is measured at a predetermined pitch, that is, the average width of the protrusion for each predetermined pitch is larger as the protruding portions approach the vibration plate, in addition to the configuration of the cross-sectional triangle as described above and the configuration of the R portion.

### E. Other Embodiments

1. The present disclosure can be implemented as a liquid discharging head described below. For example, the liquid discharging head includes a pressure chamber substrate that has a pressure chamber space partitioned by side walls; a vibration plate that overlaps the pressure chamber substrate and covers the pressure chamber space to form one surface of a pressure chamber; a piezoelectric element that is formed on the vibration plate, and in which a lower electrode, a piezoelectric layer, and an upper electrode are stacked in a thickness direction of the vibration plate as a stacking direction; a protective film that is provided on a side opposite to the pressure chamber space of the vibration plate and covers at least a part of the vibration plate. Here, a protruding portion is provided that is formed toward an inside of the pressure chamber space is provided with respect to a surface of the side wall as a reference at a coupling section where at least one of the side walls present in the first direction which is the longitudinal direction of the pressure chamber space is in contact with the vibration plate, and, when the pressure chamber is viewed in plan view, the protective film is provided from the outside to the inside of the pressure chamber up to a position that covers at least the protruding portion.

In this way, the liquid discharging head can relax the stress applied to the vibration plate in the vicinity of the side wall of the pressure chamber by providing the protruding portion. Moreover, even when the protruding portion the boundary between the protruding portion and the bottom surface of the vibration plate is formed to be thin and has low durability, it is possible to suppress the risk of cracking from the thin section. This is because the protective film covering the protruding portion is provided, so that the stress applied to the protruding portion or the boundary between the protruding portion and the vibration plate can be reduced. As a result, it is possible to reduce the risk of occurrence of cracks or fractures in the protruding portion or the boundary.

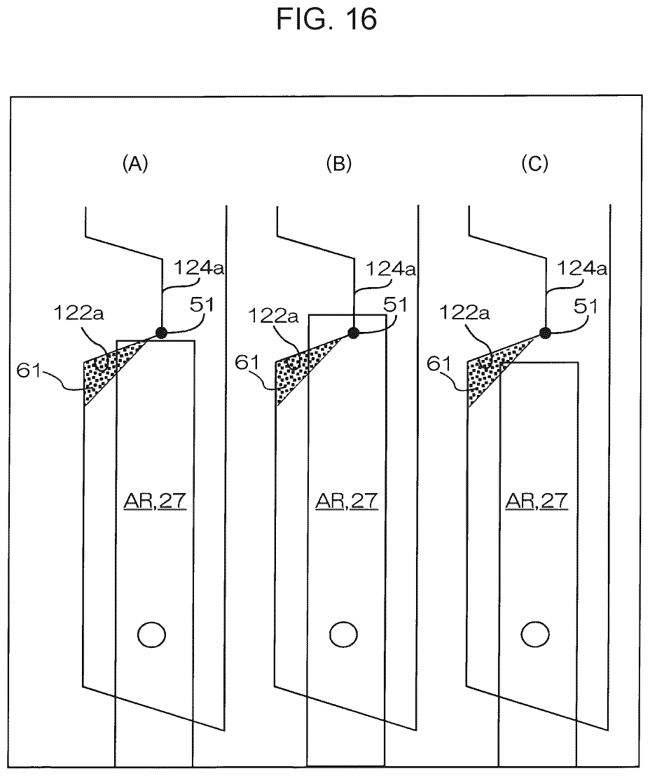

In the liquid discharging head, the piezoelectric element can be disposed in various ways. When the side wall that is present in the first direction, which is the longitudinal direction of the pressure chamber space, has the protruding portion that protrudes along the vibration plate front surface at the end portion that is in contact with the vibration plate, several dispositions are conceivable for the relationship between the piezoelectric element, particularly, the active portion and the side wall, as illustrated in FIG. 16. The drawing illustrates three typical dispositions with the first embodiment as an example. Here, the active portion is a portion in which the piezoelectric layer is interposed between the lower electrode and the upper electrode in the piezoelectric element. In the drawing, the lower electrode 27 corresponding to the active portion AR is illustrated by an outer line so that the positional relationship with other members can be easily understood.

As illustrated in the drawing, when the pressure chamber 22 is viewed in plan view, the active portion AR, here, the lower electrode 27 can be disposed at a position that overlaps a part of the first pressure chamber side wall 122a, which is a side wall of the pressure chamber 22 side that forms the corner portion 51, at the end portion of the piezoelectric element 19 in the first direction (x direction), which is the longitudinal direction of the piezoelectric element 19, and that does not overlap the corner portion 51. This is the disposition in (A) of FIG. 16. With such a disposition, the stress applied to the protruding portion 61 is relaxed by the protective film, and the protruding portion 61 is less likely to be cracked or fractured. In addition, the active portion AR does not overlap the corner portion 51, and thus the stress from the active portion AR is not applied to the corner portion 51. Therefore, it is possible to suppress the piezoelectric element 19 from cracking or fracturing at the section of the corner portion 51.

The end portion of the lower electrode 27 forming the active portion AR on the flow path 24 side can be disposed to overlap the corner portion 51. This is the disposition illustrated in (B) of FIG. 16. In this manner, the stress applied to the protruding portion 61 can be dispersed. That is, since the lower electrode 27 is extended to the first pressure chamber side wall 122a, the fixing end of the lower electrode 27 is positioned on the first pressure chamber side wall 122a, and thus the stress applied to the protruding portion 61 can be dispersed. As illustrated in (C) of FIG. 16, the end portion of the lower electrode 27 forming the active portion AR on the flow path 24 side can be disposed so as not to overlap any of the pressure chamber side walls 122 constituting the pressure chamber 22. In this way, a predetermined distance can be provided between the section of the lower electrode 27 where the stress is concentrated and the protruding portion 61, and the stress transmitted to the protruding portion 61 can be relaxed. Further, since the lower electrode 27 does not overlap the pressure chamber side wall 122, the stress transmitted to the side wall 122 is reduced, and so-called crosstalk in which the stress is transmitted to the adjacent pressure chambers 22 can also be suppressed.

The dispositions of (A) to (C) of FIG. 16 indicate the disposition of the lower electrode 27 that forms the active portion AR, but the configuration of the lower electrode 27 and the upper electrode 29 may be changed, and the upper electrode 29 that forms the active portion AR may be disposed as the lower electrode 27 illustrated in (A) to (C) of the drawing. In this case, the upper electrode 29 becomes an individual electrode, and the lower electrode 27 becomes a common electrode.

Here, the corner portion may be formed at a coupling location between the pressure chamber and the flow path as long as the side wall of the pressure chamber substrate is formed, and the formed corner portion may be, for example, a protrusion formed by the side wall of the pressure chamber itself, or may be a corner portion where the side wall of the pressure chamber substrate is in contact with the side wall forming the flow path at an angle of more than 180 degrees. The corner portion may be a so-called pin corner in which the adjacent side walls are in contact with each other, or may be provided with a degree of roundness (R) that occurs during manufacturing, an intentional rounded portion or a chamfered portion.

In such a liquid discharging head, the central portion of the vibration plate may have a shape slightly swelled downward, that is, a convex shape on the pressure chamber side as compared with the peripheral portion in a non-operating state in which a voltage is not applied to the piezoelectric element. Since the vibration plate has a downward convex shape, the protruding portion does not receive a force from the vibration plate when the piezoelectric element is not operated, and the reliability can be improved.

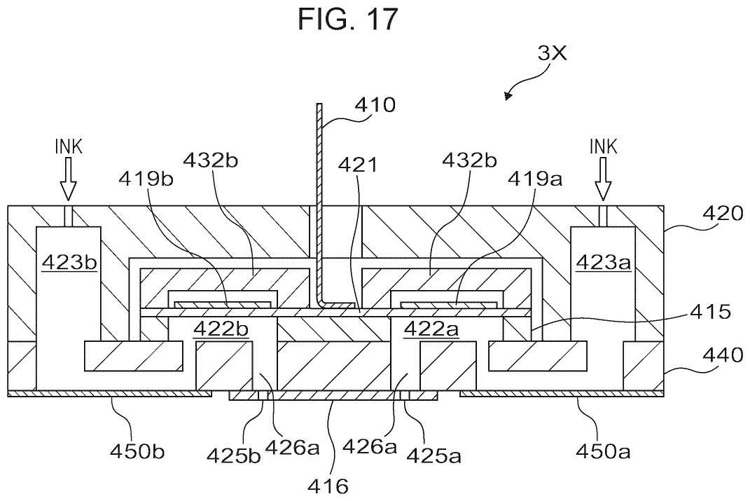

As described in the first to fifth embodiments, in the liquid discharging head, the pressure chamber space is partitioned by a plurality of side walls surrounding the pressure chamber space. The pressure chamber can be configured by covering one surface of the pressure chamber space with the vibration plate and providing the nozzle plate at a position facing the vibration plate as illustrated in FIG. 4 and the like. In this manner, when the piezoelectric element provided on the vibration plate is driven, the vibration plate is bent to change the pressure of the liquid in the pressure chamber, and the liquid is discharged from the nozzle. The pressure chamber is not limited to such a configuration, and the nozzle can be provided at a position from the pressure chamber via a communication path. An example of such a liquid discharging head is illustrated in FIG. 17.

A liquid discharging head 3X is configured by stacking a communication substrate 440, a pressure chamber substrate 415, and a sealing case 420 in this order from the bottom. A groove and an opening portion are formed and stacked on each substrate, thereby configuring the flow path and the pressure chamber. A nozzle plate 416 is provided at the bottom of the liquid discharging head 3X, and two rows of nozzles are provided. In the drawing, nozzles 425a and 425b are illustrated. Two pressure chambers 422a and 422b and two piezoelectric elements 419a and 419b are provided to correspond to the two nozzles 425a and 425b. A common vibration plate 421 is provided in the two pressure chambers 422a and 422b, and the piezoelectric elements 419a and 419b are provided on the vibration plate 421 to correspond to the respective pressure chambers 422a and 422b. The vibration plate 421 may be provided for each of the pressure chambers 422a and 422b. The piezoelectric elements 419a and 419b are accommodated in the sealing plates 432a and 432b, respectively. A signal line 410 is coupled to the piezoelectric elements 419a and 419b, so that a drive signal can be received from the outside.

Reservoirs 423a and 423b that are supplied with liquid, here, ink from an ink cartridge or the like and store the liquid are provided at both ends of the liquid discharging head 3X. Compliance substrates 450a and 450b are provided below the reservoirs 423a and 423b. The opening at the lower portion of the communication substrate 440 is closed by the compliance substrates 450a and 450b. Thus, a communication path is formed in the communication substrate 440, and the ink in the reservoirs 423a and 423b is supplied to the pressure chambers 422a and 422b via the communication path. Each of the pressure chambers 422a and 422b communicates with nozzle flow paths 426a and 426b formed in the communication substrate 440, and the nozzle flow paths 426a and 426b are sealed by the nozzle plate 416. Therefore, when the piezoelectric elements 419a and 419b are driven and the pressure in each of the pressure chambers 422a and 422b fluctuates, the pressure fluctuation also occurs in the nozzle flow paths 426a and 426b, and the pressure fluctuation causes ink droplets to be discharged from the nozzles 425a and 425b.

As described above, the configuration of the pressure chamber of the liquid discharging head is not limited to the configuration in the above-described embodiment, and various known configurations can be adopted. Here, all the ink flowing from the reservoirs 423a and 423b to the nozzle flow paths 426a and 426b is discharged from the nozzles 425a and 425b, but the ink may be supplied from the supply-side reservoir to the pressure chambers 422a and 422b and the nozzle flow paths 426a and 426b, and further collected in the collection reservoir. The collected ink may be circulated between the ink tank and the liquid discharging head by a pump or the like.

2. In the above configuration, the protruding portion may include at least one of <1> a portion that protrudes from the side wall in contact with the vibration plate along a surface of the vibration plate at the coupling section, and <2> a portion in which a thickness of the vibration plate is increased over a predetermined range from a section in contact with the side wall toward a center portion of the pressure chamber space at the coupling section. In this way, even when the protruding portion is provided on the side wall, is provided as a part of the vibration plate, or is provided on both of the side walls, the stress applied to the vibration plate in the vicinity of the side wall of the pressure chamber can be relaxed.

When including the portion of <1>, the protruding portion may be formed by intentionally leaving the material when etching the material of the pressure chamber substrate, such as a silicon single crystal substrate, to form the pressure chamber, or may be formed as a remaining portion that is generated due to the speed at which etching of the corner portion progresses. When including the portion of <2>, the protruding portion may be formed by making the thickness of the vibration plate thicker than the other over a predetermined range from the section in contact with the side wall toward the center portion of the pressure chamber space, and for example, the thickness of the vibration plate may be made thicker as the protruding portion approaches the outer periphery of the pressure chamber space. The predetermined range increasing the thickness of the vibration plate may be a range of a constant distance from the outer periphery of the pressure chamber space toward the inside of the pressure chamber space, and may be a different range for each direction such as the first direction or the direction intersecting the first direction. In either case <1> or <2>, the method of manufacturing is not limited. Naturally, other configurations may be adopted, for example, a configuration in which the protruding portion forming substrate is disposed between the vibration plate and the pressure chamber substrate to form the protruding portion.

3. In the configuration of 1 or 2, when the pressure chamber is viewed in plan view, a total length of protrusion of the protruding portion along the first direction may be longer than a length between a tip end portion of the protruding portion and a terminal of the protective film. In this way, the stress transmitted to the protruding portion due to the displacement of the piezoelectric element can be relaxed by the protective film. Since the total length of the protruding portion is longer than the length to the terminal of the protective film, a region contributing to stress relaxation can be sufficiently secured, and the stress applied to the tip end of the protruding portion can be further reliably relaxed. Naturally, even in a configuration in which the magnitude relationship between the two is reversed, it is still possible to relax the stress applied to the tip end of the protruding portion.

4. In the configuration of 1 to 3, when the pressure chamber is viewed in plan view, a length from the side wall in which the protruding portion is present to a tip end portion of the protective film may be shorter than a length of the pressure chamber in a second direction intersecting the first direction. In this way, the displacement amount of the piezoelectric element in the second direction can be increased. Further, since the length covered by the protective film is shorter than the width of the pressure chamber, it is possible to secure the displacement of the vibration plate by the piezoelectric element in the pressure chamber, and further suppress the occurrence of cracks or fractures in the protruding portion. Naturally, even in a configuration in which the magnitude relationship between the two is reversed, it is still possible to suppress the occurrence of cracks or fractures in the protruding portion.

5. In the configurations of 1 to 4, a length between a tip end portion of the protruding portion and a tip end portion of the protective film may be longer than a sum of thicknesses of the vibration plate, the piezoelectric element, and the protective film in the stacking direction. In this way, the displacement of the vibration plate is likely to decrease in the first direction, so that the stress applied to the protruding portion can be further relaxed, and as a result, the occurrence of cracks or fractures in the protruding portion can be further suppressed. Naturally, even in a configuration in which the magnitude relationship between the two is reversed, it is still possible to suppress the occurrence of cracks or fractures in the protruding portion.

6. In the configurations of 1 to 5, when a thickness of the protective film in the stacking direction is defined as T, a Young's modulus of the protective film is defined as Ea, a sum of thicknesses of the vibration plate and the piezoelectric element is defined as S, and a Young's modulus of the vibration plate and the piezoelectric element is defined as Eb, the following formula [1] may be satisfied.

$$T \cdot Ea < S \cdot Eb . \qquad [ 1 ]$$

7. Similarly, when a ratio rE of a product of the Young's modulus and the thickness of each of the sections is defined as the following formula [2], the ratio rE may satisfy the following inequality [3],

$$rE = ( T \cdot Ea ) / ( S \cdot Eb ) , \qquad [ 2 ]$$

$$0.01 \leq rE \leq 0.04 . \qquad [ 3 ]$$

These relationships are equivalent to the rigidity of the protective film being lower than the rigidity of the vibration plate. In this way, it is possible to suppress sharp change in deflection caused by the piezoelectric element in the vicinity of the protective film, and to suppress the concentration of the stress in a narrow range. That is, it is possible to avoid a situation in which the rigidity of the protective film is too high, and to further suppress the influence of the displacement of the piezoelectric element. Naturally, even when the on-table relationship indicated by the inequality is reversed, that is, T·Ea≥S·Eb, the occurrence of cracks or fractures in the protruding portion can be suppressed.

8. In the configurations of 1 to 7, the lower electrode may be an individual electrode that is individually provided for a plurality of the piezoelectric elements, the upper electrode may be a common electrode that is commonly provided for the plurality of piezoelectric elements, and when the pressure chamber is viewed in plan view, the upper electrode may cover the protruding portion. In this way, when the upper electrode that is continuous as the common electrode in the second direction (width direction) covers the protruding portion, the protruding portion is covered with the same material in the second direction (width direction) and the first direction (longitudinal direction). Therefore, it is possible to suppress the variation in the stress applied to the protruding portion depending on the direction.

9. In the configurations of 1 to 8, the protective film may include a first protective film that is provided on the upper electrode, and a second protective film that is provided on the first protective film and has a higher rigidity than a rigidity of the first protective film, with the stacking direction as a vertical direction. As described above, when the second protective film is provided, the stress applied to the tip end of the protruding portion can be further relaxed. The first protective film can be formed of a metal or a non-metal. As the metal, for example, NiCr, TiW, Pt, or the like can be used. Furthermore, various metals such as Ni, Al, Cu, Au, Ti, W, and Ir can be used. In addition, various oxides and nitrides can be used as the non-metal, and, for example, TaOₓ, AlOₓ, SiNₓ, SiO₂, ITO, and, further, TiO₂, ZrO₂, CrOₓ, and the like can also be used.

10. In the configurations of 1 to 9, when the pressure chamber is viewed in plan view, a tip end portion of the second protective film may protrude from a tip end portion of the first protective film at a tip end portion of the protective film. In this way, when the displacement is repeated so that the piezoelectric element has an upward convex shape, it is possible to suppress the possibility that the second protective film is damaged due to fatigue. When viewed from the second protective film, the tip end of the first protective film has a shape that is recessed inward by a predetermined length. Such a shape can be formed by performing isotropic etching using the second protective film as a mask, or the like. Naturally, after the first protective film is formed, the second protective film may be formed by vapor deposition or the like so as to cover the tip end of the first protective film, that is, the tip end of the second protective film may be formed to protrude from the first protective film.

11. In the configurations of 1 to 10, the vibration plate may be provided with a first region in which the piezoelectric layer is not provided and one of the upper electrode and the lower electrode is provided, over a predetermined range along the first direction in a second direction intersecting the first direction, and, when the pressure chamber is viewed in plan view, the protective film provided from the outside to the inside of the pressure chamber may overlap a tip end portion of the first region in the first direction. In this way, since the protective film covers a part of the first region that facilitates the vibration of the vibration plate due to the operation of the piezoelectric element, it is possible to suppress the occurrence of cracks, fractures, or the like at the tip end portion of the first region. The width of the overlap may be such that the protective film overlaps only the tip end portion of the first region, or the protective film may be further extended in the first direction to increase the width of the overlap. The degree of overlapping may be determined based on the magnitude of the generated stress, the discharge amount of the liquid discharged from the nozzle due to the displacement of the vibration plate, and the like.

12. In the configurations of 1 to 11, the tip end portion of the first region in the first direction may have a tapered shape toward the first direction, and, when the pressure chamber is viewed in plan view, a width of overlap between the protective film and the first region along the first direction may be 6.2 μm or more and 16.2 μm or less. Since the first region is present when the piezoelectric element is driven, the vibration plate is largely deflected due to the presence of the first region, but the stress due to the deflection can be treated as the second-order differential value of the deflection amount, so that the range of the width of the overlap in which the cracks, fractures, or the like are unlikely occur in the vibration plate, the piezoelectric layer or the like can be obtained based on the actual measurement. According to the actual measurement, for example, when the pressure chamber is viewed in plan view, it is found that the width of the overlap between the protective film and the first region along the first direction is preferably in the range of at least 6.2 μm and at most 16.2 μm.

13. In the configuration of 11, the protective film may include a first protective film that is provided on the upper electrode and a second protective film that is provided on the first protective film and has higher rigidity than a rigidity of the first protective film, with the stacking direction as the vertical direction, when the pressure chamber is viewed in plan view, the protective film may overlap the tip end portion of the first region in the first direction, hillocks may be formed by a reaction between a material configuring the first protective film and a material configuring the second protective film on the second protective film, and the number of hillocks per unit area at a position where the first protective film and the first region overlap may be less than the number of hillocks per unit area on the second protective film. When the hillock is present in the portion that alleviates the stress, the stress is concentrated on the hillock and the possibility of cracks or fractures occurring from the hillock as the starting point is increased. However, the hillock is less likely to occur at the tip end of the first region in which the amplitude of the vibration is likely to increase when the piezoelectric element 19 is driven. Therefore, it is possible to suppress the occurrence of the crack or the fracture from the hillock as the starting point.

14. In the configurations of 1 to 13, the side wall that may be present in the first direction includes a corner portion, and, in an end portion in the first direction, when the pressure chamber is viewed in plan view from the vibration plate side, an active portion, which is a portion where the piezoelectric layer is interposed between the lower electrode and the upper electrode in the piezoelectric element, may be provided with either (A) a first disposition that overlaps a part of the side wall including the protruding portion and does not overlap the corner portion, (B) a second disposition that overlaps a part of the side wall including the protruding portion and the corner portion, or (C) a third disposition that does not overlap the side wall including the protruding portion and the corner portion.

When the first disposition of (A) is adopted, the stress applied to the protruding portion by the protective film is relaxed, and the protruding portion is less likely to be cracked or fractured. In addition, the active portion does not overlap the corner portion, and thus the stress from the active portion is not applied to the corner portion. Therefore, it is possible to suppress the piezoelectric element from cracking or fracturing at the section of the corner portion. When the second disposition of (B) is adopted, the stress applied to the protruding portion can be dispersed. When the third disposition of (C) is adopted, a predetermined distance can be provided between the section of the active portion where the stress is concentrated and the protruding portion, and the stress transmitted to the protruding portion can be relaxed. Further, since the active portion does not overlap the side wall of the pressure chamber, the stress transmitted to the side wall is reduced, and so-called crosstalk in which the stress is transmitted to the adjacent pressure chamber can also be suppressed.

The present disclosure is not limited to the above-described embodiments, and can be realized in various configurations without departing from the gist of the present disclosure. For example, the technical features in the embodiments corresponding to technical features in respective aspects described in summary of the present disclosure can be replaced or combined as appropriate in order to solve some or all of the above-described problems or to achieve some or all of the above-described effects. Further, when the technical features are not described as essential in the present specification, the technical features can be appropriately deleted. For example, a part of the configuration realized by the hardware in the above embodiments can be realized by the software.

What is claimed is:

1. A liquid discharging head comprising:
a pressure chamber substrate that has a pressure chamber space partitioned by side walls;
a vibration plate that overlaps the pressure chamber substrate and covers the pressure chamber space to form one surface of a pressure chamber;
a piezoelectric element that is formed on the vibration plate, and in which a lower electrode, a piezoelectric layer, and an upper electrode are stacked in a thickness direction of the vibration plate as a stacking direction;
a protective film that is provided on the piezoelectric element; and
a protruding portion that is formed toward an inside of the pressure chamber space is provided with respect to a surface of the side wall as a reference at a coupling section where at least one of the side walls present in a first direction which is a longitudinal direction of the pressure chamber space is in contact with the vibration plate, and wherein
when the pressure chamber is viewed in plan view from a vibration plate side, the protective film is provided from an outside to the inside of the pressure chamber up to a position that covers at least the protruding portion.

2. The liquid discharging head according to claim 1, wherein
the protruding portion includes at least one of
<1> a portion that protrudes from the side wall in contact with the vibration plate along a surface of the vibration plate at the coupling section, and
<2> a portion in which a thickness of the vibration plate is increased over a predetermined range from a section in contact with the side wall toward a center portion of the pressure chamber space at the coupling section.

3. The liquid discharging head according to claim 1, wherein
the pressure chamber substrate has the extension portion, and
the protruding portion protrudes from the side wall in contact with the vibration plate along a surface of the vibration plate at the coupling section.

4. The liquid discharging head according to claim 1, wherein
the vibration plate has the protruding portion, and
a thickness of the vibration is increased over a predetermined range from a section in contact with the side wall toward a center portion of the pressure chamber space at the coupling section.

5. The liquid discharging head according to claim 1, wherein
when the pressure chamber is viewed in plan view, a total length of protrusion of the protruding portion along the first direction is longer than a length between a tip end portion of the protruding portion and a terminal of the protective film.

6. The liquid discharging head according to claim 1, wherein
when the pressure chamber is viewed in plan view, a length from the side wall in which the protruding portion is present to a tip end portion of the protective film is shorter than a length of the pressure chamber in a second direction intersecting the first direction.

7. The liquid discharging head according to claim 1, wherein
a length between a tip end portion of the protruding portion and a tip end portion of the protective film is longer than a sum of thicknesses of the vibration plate, the piezoelectric element, and the protective film in the stacking direction.

8. The liquid discharging head according to claim 1, wherein
when a thickness of the protective film in the stacking direction is defined as T, a Young's modulus of the protective film is defined as Ea, a sum of thicknesses of the vibration plate and the piezoelectric element is defined as S, and a Young's modulus of the vibration plate and the piezoelectric element is defined as Eb, the following formula [1] is satisfied,
$$T \cdot Ea < S \cdot Eb . \qquad [ 1 ]$$

9. The liquid discharging head according to claim 8, wherein
when a ratio rE of a product of the Young's modulus and the thickness of each of the sections is defined as the following formula [2], the ratio rE satisfies the following inequality [3],
$$rE = ( T \cdot Ea ) / ( S \cdot Eb ) , \qquad [ 2 ]$$
$$0.03 \leq rE \leq 0.04 . \qquad [ 3 ]$$

10. The liquid discharging head according to claim 1, wherein
the lower electrode is an individual electrode that is individually provided for a plurality of the piezoelectric elements,
the upper electrode is a common electrode that is commonly provided for the plurality of piezoelectric elements, and
when the pressure chamber is viewed in plan view, the upper electrode covers the protruding portion.

11. The liquid discharging head according to claim 10, wherein
the protective film includes a first protective film that is provided on the upper electrode, and a second protective film that is provided on the first protective film and has a higher rigidity than a rigidity of the first protective film.

12. The liquid discharging head according to claim 11, wherein
when the pressure chamber is viewed in plan view, a tip end portion of the second protective film protrudes from a tip end portion of the first protective film at a tip end portion of the protective film.

13. The liquid discharging head according to claim 10, wherein
the vibration plate is provided with a first region in which the piezoelectric layer is not provided and one of the upper electrode and the lower electrode is provided, over a predetermined range along the first direction in a second direction intersecting the first direction, and
when the pressure chamber is viewed in plan view, the protective film provided from the outside to the inside of the pressure chamber overlaps a tip end portion of the first region in the first direction.

14. The liquid discharging head according to claim 13, wherein
the tip end portion of the first region in the first direction has a tapered shape toward the first direction, and
when the pressure chamber is viewed in plan view, a width of overlap between the protective film and the first region along the first direction is 6.2 μm or more and 16.2 μm or less.

15. The liquid discharging head according to claim 13, wherein
the protective film includes a first protective film that is provided on the upper electrode and a second protective film that is provided on the first protective film and has higher rigidity than a rigidity of the first protective film,
when the pressure chamber is viewed in plan view, the protective film overlaps the tip end portion of the first region in the first direction,
hillocks are formed by a reaction between a material configuring the first protective film and a material configuring the second protective film on the second protective film, and
the number of hillocks per unit area at a position where the first protective film and the first region overlap is less than the number of hillocks per unit area on the second protective film.

16. The liquid discharging head according to claim 1, wherein
the side wall that is present in the first direction includes a corner portion, and
when the pressure chamber is viewed in plan view from the vibration plate side, at an end portion in the first direction, an active portion, which is a portion where the piezoelectric layer is interposed between the lower electrode and the upper electrode in the piezoelectric element, is provided with either
(A) a first disposition that overlaps a part of the side wall including the protruding portion and the corner portion, or
(B) a third disposition that does not overlap the side wall including the protruding portion and the corner portion.

17. The liquid discharging head according to claim 1, wherein
the side wall that is present in the first direction includes a corner portion, and
when the pressure chamber is viewed in plan view from the vibration plate side, at an end portion in the first direction, an active portion, which is a portion where the piezoelectric layer is interposed between the lower electrode and the upper electrode in the piezoelectric element, overlaps a part of the side wall including the protruding portion and does not overlap the corner portion.
